(19) United States
(12) Patent Application Publication
(10) Pub. No.: US 2026/0214218 A1
(43) Pub. Date: Jul. 23, 2026

(54) SELECTION OF FRAME RATE UPSAMPLING FILTER

(71) Applicant: Nokia Technologies Oy, Espoo (FI)

(72) Inventor: Miska Matias HANNUKSELA, Tampere (FI)

(21) Appl. No.: 19/143,762

(22) PCT Filed: Dec. 28, 2023
(86) PCT No.: PCT/IB2023/063333

§ 371 Date: Jun. 26, 2025

Related U.S. Application Data
(60) Provisional application No. 63/478,270, filed on Jan. 3, 2023.

(51) Int. Cl. H04N 19/117; H04N 19/172; H04N 19/196; H04N 19/30; H04N 19/70; H04N 19/80; H04N 19/86

(52) U.S. Cl. CPC H04N 19/117; H04N 19/172; H04N 19/196; H04N 19/30; H04N 19/70; H04N 19/80; H04N 19/86

(57) ABSTRACT

Various embodiments provide an apparatus, a method, and a computer program product. An example apparatus includes: at least one processor; and at least one memory storing instructions that, when executed by the at least one processor, cause the apparatus at least to perform: determining that a temporal interleaving frame packing arrangement is in use in a bitstream; determining a constituent frame parity that a current frame where a frame rate upsampling filter is activated has frame packing arrangement for the temporal interleaving; selecting one or more input frames for the frame rate upsampling filter comprising the determined constituent frame parity; and applying the frame rate upsampling filter with the one or more input frames as input.

### TECHNICAL FIELD

The teachings in accordance with the exemplary embodiments of this invention relate generally to video coding, more specifically, relate to selection of a frame rate upsampling filter and its input frames.

### BACKGROUND

It is known to perform video coding.

### SUMMARY

Example 1. A method, comprising: determining that a temporal interleaving frame packing arrangement is in use in a bitstream; determining a constituent frame parity that a current frame where a frame rate upsampling filter is activated has frame packing arrangement for the temporal interleaving; selecting one or more input frames for the frame rate upsampling filter comprising the determined constituent frame parity; and applying the frame rate upsampling filter with the one or more input frames as input. Examples of the frame rate upsampling filter includes, but is not limited to, a frame rate upsampling post-filter or a frame rate upsampling post-processing filter.

Example 2. A method, comprising: determining that a temporal interleaving frame packing arrangement is in use in a bitstream; selecting one or more input frames for a frame rate upsampling filter; and applying the frame rate upsampling filter with the one or more input frames and information indicative of the temporal interleaving frame packing arrangement as inputs. Examples of the frame rate upsampling filter includes, but is not limited to, a frame rate upsampling post-filter or a frame rate upsampling post-processing filter.

Example 3. The method of example 2 further comprising: determining a constituent frame parity for each input frame, of the one or more input frames, for the temporal interleaving frame packing arrangement; and providing the constituent frame parity for the each input frame as input when applying the frame rate upsampling filter.

Example 4. The method of example 2 further comprising: determining a constituent frame parity that a current frame where the frame rate upsampling filter is activated has for the temporal interleaving frame packing arrangement; and providing the constituent frame parity for the current frame as an input when applying the frame rate upsampling filter.

Example 5. The method of example 4 further comprising, assuming that the other input frames have alternating constituent frame parities, when the frame rate upsampling filter receives the constituent frame parity as the input.

Example 6. The method of example 5 further comprising assuming in the frame rate upsampling filter that the current frame being constituent frame 0 indicates that the previous input frame is constituent frame 1 of a different timestamp.

Example 7. The method of example 5 further comprising assuming in the frame rate upsampling filter that the current frame being constituent frame 1 indicates that the previous input frame is constituent frame 0 of the same timestamp.

Example 8. A method comprising: receiving a bitstream comprising two or more input frames among which at least some frames have different widths and heights, providing the widths and heights of the two or more input frames as input to a frame rate upsampling filter; and applying the frame rate upsampling filter to the two or more input frames. Examples of the frame rate upsampling filter includes, but is not limited to, a frame rate upsampling post-filter or a frame rate upsampling post-processing filter.

Example 9. A method comprising: signaling information that a frame rate upsampling filter is applicable to two or more input frames as input; and constraining the two or more input frames to have same or substantially same width and height. Examples of the frame rate upsampling filter includes, but is not limited to, a frame rate upsampling post-filter or a frame rate upsampling post-processing filter.

Example 10. A method comprising: signaling a first information that a super resolution filter is applicable to one or more frames; and signaling a second information that a frame rate upsampling filter is applicable to two or more frames as input, wherein an intersection of the two or more frames and the one or more frames is non-empty, and wherein the two or more frames have the same width and height subsequent to applying the super resolution filter to the one or more frames. Examples of the frame rate upsampling filter includes, but is not limited to, a frame rate upsampling post-filter or a frame rate upsampling post-processing filter.

Example 11. A method comprising: determining that a super resolution filter is applicable to one or more frames; determining that a frame rate upsampling filter is applicable to two or more frames as input, wherein an intersection of the two or more frames and the one or more frames is non-empty; applying the super resolution filter to the one or more frames to obtain two or more equal or substantially equal resolution input frames; and applying the frame rate upsampling filter to the two or more equal or substantially equal resolution input frames. Examples of the frame rate upsampling filter includes, but is not limited to, a frame rate upsampling post-filter or a frame rate upsampling post-processing filter.

Example 12. The method example 11 further comprises: applying the super resolution filter, when an input frame to the super resolution filter comprising an incompatible width or height as an to be an input to the frame rate upsampling filter of the two or more input frames.

Example 13. A method comprising: determining whether a frame rate upsampling filter is applicable to two or more equal or substantially equal resolution input frames as input; selecting a current frame wherein the frame rate upsampling filter is activated to be among the two or more equal or substantially equal resolution input frames; selecting one or more frames preceding the current frame and comprising the same or substantially same width and height as the current frame to be among the two or more equal or substantially equal resolution input frames; and applying the frame rate upsampling filter to the two or more equal or substantially equal resolution input frames. Examples of the frame rate upsampling filter includes, but is not limited to, a frame rate upsampling post-filter or a frame rate upsampling post-processing filter.

Example 14. A method comprising: defining a frame rate upsampling filter using an indication message; and indicating in the indication message a range of one or more temporal identifier values, indicative that the frame rate upsampling filter is applicable when a highest temporal identifier value for decoding is within the range. Some examples of the indication message include, but are not limited to, neural-network filter characteristics (NNPFC) and neural-network filter activation (NNPFA) supplemental enhancement information (SEI) messages. Examples of the frame rate upsampling filter includes, but is not limited to, a frame rate upsampling post-filter or a frame rate upsampling post-processing filter.

Example 15. The method of example 14, wherein when a sub-bitstream is extracted with the highest temporal identifier value in the sub-bitstream being any value within the range of one or more temporal identifier values, the frame rate upsampling filter is applicable for the sub-bitstream, and wherein when the sub-bitstream is extracted with the highest temporal identifier value in the sub-bitstream being outside of the range of one or more temporal identifier values, the frame rate upsampling filter is not applicable for the sub-bitstream.

Example 16. A method comprising: signaling a first information that a super resolution filter is applicable to one or more frames; signaling a second information that a frame rate upsampling filter is applicable to two or more input frames as input; and signaling a processing order indication between the super resolution filter and the frame rate upsampling filter, wherein the processing order applies to an intersection of the two or more frames and the one or more frames, and wherein the processing order is such that the two or more input frames to the frame rate upsampling filter have the same or substantially same widths and heights. Examples of the frame rate upsampling filter includes, but is not limited to, a frame rate upsampling post-filter or a frame rate upsampling post-processing filter.

Example 17. The method of example 16 further comprising including a first type value, a first identifier value, a second type value, and a second identifier value in the processing order indication to indicate the respective processing order of the frame rate upsampling filter and the super resolution filter.

Example 18. A method comprising: receiving a first information that a super resolution filter is applicable to one or more frames; receiving a second information that a frame rate upsampling filter is applicable to two or more input frames as input; and receiving a processing order indication between the super resolution filter and the frame rate upsampling filter, wherein the processing order applies to an intersection of the two or more frames and the one or more frames, and wherein the processing order is such that the two or more input frames to the frame rate upsampling filter have the same or substantially same widths and heights. Examples of the frame rate upsampling filter includes, but is not limited to, a frame rate upsampling post-filter or a frame rate upsampling post-processing filter.

Example 19. The method of example 18 further comprising: receiving a first type value, a first identifier value, a second type value, and a second identifier value in the processing order indication, wherein the first type value, the first identifier value, the second type value, and the second identifier value indicates the respective processing order of the frame rate upsampling filter and the super resolution filter; and decoding the first type value, the first identifier value, the second type value and the second identifier value from the processing order indication, to determine the respective processing order of the frame rate upsampling filter and the super resolution filter.

Example 20. An apparatus comprising: at least one processor; and at least one memory storing instructions that, when executed by the at least one processor, cause the apparatus at least to perform: determining that a temporal interleaving frame packing arrangement is in use in a bitstream; determining a constituent frame parity that a current frame where a frame rate upsampling filter is activated has frame packing arrangement for the temporal interleaving; selecting one or more input frames for the frame rate upsampling filter comprising the determined constituent frame parity; and applying the frame rate upsampling filter with the one or more input frames as input. Examples of the frame rate upsampling filter includes, but is not limited to, a frame rate upsampling post-filter or a frame rate upsampling post-processing filter.

Example 21. An apparatus comprising: at least one processor; and at least one memory storing instructions that, when executed by the at least one processor, cause the apparatus at least to perform: determining that a temporal interleaving frame packing arrangement is in use in a bitstream; selecting one or more input frames for a frame rate upsampling filter; and applying the frame rate upsampling filter with the one or more input frames and information indicative of the temporal interleaving frame packing arrangement as inputs. Examples of the frame rate upsampling filter includes, but is not limited to, a frame rate upsampling post-filter or a frame rate upsampling post-processing filter.

Example 22. The apparatus of example 21, wherein the apparatus is further caused to perform: determining a constituent frame parity for each input frame, of the one or more input frames, for the temporal interleaving frame packing arrangement; and providing the constituent frame parity for the each input frame as input when applying the frame rate upsampling filter.

Example 23. The apparatus of example 21, wherein the apparatus is further caused to perform: determining a constituent frame parity that a current frame where the frame rate upsampling filter is activated has for the temporal interleaving frame packing arrangement; and providing the constituent frame parity for the current frame as an input when applying the frame rate upsampling filter.

Example 24. The apparatus of example 23, wherein the apparatus is further caused to perform: assuming that other input frames have alternating constituent frame parities, when the frame rate upsampling filter receives the constituent frame parity as the input.

Example 25. The apparatus of example 24, wherein the apparatus is further caused to perform: assuming in the frame rate upsampling filter that the current frame being constituent frame 0 indicates that previous input frame is constituent frame 1 of a different timestamp.

Example 26. The apparatus of example 24, wherein the apparatus is further caused to perform: assuming in the frame rate upsampling filter that the current frame being constituent frame 1 indicates that previous input frame is constituent frame 0 of the same timestamp.

Example 27. An apparatus comprising: at least one processor; and at least one memory storing instructions that, when executed by the at least one processor, cause the apparatus at least to perform: receiving a bitstream comprising two or more input frames among which at least some frames have different widths and heights; providing the widths and heights of the two or more input frames as input to a frame rate upsampling filter; and applying the frame rate upsampling filter to the two or more input frames. Examples of the frame rate upsampling filter includes, but is not limited to, a frame rate upsampling post-filter or a frame rate upsampling post-processing filter.

Example 28. An apparatus comprising: at least one processor; and at least one memory storing instructions that, when executed by the at least one processor, cause the apparatus at least to perform: signaling information that a frame rate upsampling filter is applicable to two or more input frames as input; and constraining the two or more input frames to have same or substantially same width and height. Examples of the frame rate upsampling filter includes, but is not limited to, a frame rate upsampling post-filter or a frame rate upsampling post-processing filter.

Example 29. An apparatus comprising: at least one processor; and at least one memory storing instructions that, when executed by the at least one processor, cause the apparatus at least to perform: signaling a first information that a super resolution filter is applicable to one or more frames; and signaling a second information that a frame rate upsampling filter is applicable to two or more frames as input, wherein an intersection of the two or more frames and the one or more frames is non-empty, and wherein the two or more frames have the same width and height subsequent to applying the super resolution filter to the one or more frames. Examples of the frame rate upsampling filter includes, but is not limited to, a frame rate upsampling post-filter or a frame rate upsampling post-processing filter.

Example 30. An apparatus comprising: at least one processor; and at least one memory storing instructions that, when executed by the at least one processor, cause the apparatus at least to perform: determining that a super resolution filter is applicable to one or more frames; determining that a frame rate upsampling filter is applicable to two or more frames as input, wherein an intersection of the two or more frames and the one or more frames is non-empty; applying the super resolution filter to the one or more frames to obtain two or more equal or substantially equal resolution input frames; and applying the frame rate upsampling filter to the two or more equal or substantially equal resolution input frames. Examples of the frame rate upsampling filter includes, but is not limited to, a frame rate upsampling post-filter or a frame rate upsampling post-processing filter.

Example 31. The apparatus of example 30, wherein the apparatus is further caused to perform: applying the super resolution filter, when an input frame to the super resolution filter comprising an incompatible width or height to be an input to the frame rate upsampling filter of the two or more input frames.

Example 32. An apparatus comprising: at least one processor; and at least one memory storing instructions that, when executed by the at least one processor, cause the apparatus at least to perform: determining whether a frame rate upsampling filter is applicable to two or more equal or substantially equal resolution input frames as input; selecting a current frame wherein the frame rate upsampling filter is activated to be among the two or more equal or substantially equal resolution input frames; selecting one or more frames preceding the current frame and comprising the same or substantially same width and height as the current frame to be among the two or more equal or substantially equal resolution input frames; and applying the frame rate upsampling filter to the two or more equal or substantially equal resolution input frames. Examples of the frame rate upsampling filter includes, but is not limited to, a frame rate upsampling post-filter or a frame rate upsampling post-processing filter.

Example 33. An apparatus comprising: at least one processor; and at least one memory storing instructions that, when executed by the at least one processor, cause the apparatus at least to perform: defining a frame rate upsampling filter using an indication message; and indicating in the indication message a range of one or more temporal identifier values, indicative that the frame rate upsampling filter is applicable when a highest temporal identifier value for decoding is within the range. Some examples of the indication message include, but are not limited to, neural-network filter characteristics (NNPFC) and neural-network filter activation (NNPFA) supplemental enhancement information (SEI) messages. Examples of the frame rate upsampling filter includes, but is not limited to, a frame rate upsampling post-filter or a frame rate upsampling post-processing filter.

Example 34. The apparatus of example 33, wherein when a sub-bitstream is extracted with the highest temporal identifier value in the sub-bitstream being any value within the range of one or more temporal identifier values, the frame rate upsampling filter is applicable for the sub-bitstream, and wherein when the sub-bitstream is extracted with the highest temporal identifier value in the sub-bitstream being outside of the range of one or more temporal identifier values, the frame rate upsampling filter is not applicable for the sub-bitstream.

Example 35. An apparatus comprising: at least one processor; and at least one memory storing instructions that, when executed by the at least one processor, cause the apparatus at least to perform: signaling a first information that a super resolution filter is applicable to one or more frames; signaling a second information that a frame rate upsampling filter is applicable to two or more frames as input; and signaling a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially same widths and heights. Examples of the frame rate upsampling filter includes, but is not limited to, a frame rate upsampling post-filter or a frame rate upsampling post-processing filter.

Example 36. The apparatus of example 35, wherein the apparatus is further caused to perform: including a first type value, a first identifier value, a second type value, and a second identifier value in the processing order indication to indicate the respective processing order of the frame rate upsampling filter and the super resolution filter.

Example 37. An apparatus comprising: at least one processor; and at least one memory storing instructions that, when executed by the at least one processor, cause the apparatus at least to perform: receiving a first information that a super resolution filter is applicable to one or more frames; receiving a second information that a frame rate upsampling filter is applicable with two or more frames as input; and receiving a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially same widths and heights. Examples of the frame rate upsampling filter includes, but is not limited to, a frame rate upsampling post-filter or a frame rate upsampling post-processing filter.

Example 38. The apparatus of example 37, wherein the apparatus is further caused to perform: receiving a first type value, a first identifier value, a second type value, and a second identifier value in the processing order indication, wherein the first type value, the first identifier value, the second type value, and the second identifier value indicates the respective processing order of the frame rate upsampling filter and the super resolution filter; and decoding the first type value, the first identifier value, the second type value and the second identifier value from the processing order indication, to determine the respective processing order of the frame rate upsampling filter and the super resolution filter.

Example 39. A computer-readable medium encoded with instructions that, when executed by a computer, causing an apparatus to perform methods as described in any of the examples 1 to 19.

Example 40. The computer-readable medium of example 39, wherein the computer-readable medium comprises a non-transitory computer-readable medium.

Example 41. An apparatus comprising means for performing the methods as described in any of the examples 1 to 19.

Certain abbreviations that may be found in the description and/or in the Figures are herewith defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AGT approximated ground truth data
AI artificial intelligence
AIoT AI-enabled IoT
ALF adaptive loop filtering
a.k.a. also known as
AMF access and mobility management function
APS adaptation parameter set
AVC advanced video coding
bpp bits-per-pixel
CABAC context-adaptive binary arithmetic coding
CDMA code-division multiple access
CE core experiment
ctu coding tree unit
CU central unit
CVC conventional video codec
DASH dynamic adaptive streaming over HTTP
DCT discrete cosine transform
DCI decoding compatibility information
DSP digital signal processor
DSNN decoder-side NN
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
FDC finetuning-driving content
gNB (or gNodeB) base station for 5G/NR, for example, a node providing NR user plane and control plane protocol terminations towards the UE, and connected via the NG interface to the 5GC
GSM Global System for Mobile communications
GT ground truth
H.222.0 MPEG-2 Systems is formally known as ISO/IEC 13818-1 and as ITU-T Rec. H.222.0
H.26x family of video coding standards in the domain of the ITU-T
HLS high level syntax
HQ high-quality
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
IRAP intra random access point
ISO International Organization for Standardization
ISOBMFF ISO base media file format
ITU International Telecommunication Union
ITU-T ITU Telecommunication Standardization Sector
JPEG joint photographic experts group
LCVC lossy conventional video codec
LIC learned image compression
LL-CVC lossless conventional video codec
LMCS luma mapping with chroma scaling
LPNN loss proxy NN
LQ low-quality
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
MSB most significant bit
MSE Mean-squared error
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
OBU open bitstream unit
ONNX Open Neural Network eXchange
PB protocol buffers
PC personal computer
PDA personal digital assistant
PDCP packet data convergence protocol
PHY physical layer
PID packet identifier
PLC power line communication
PNG portable network graphics
PSNR peak signal-to-noise ratio
RA Random access
RAM random access memory
RAN radio access network
RBSP raw byte sequence payload
RD loss rate distortion loss
RFC request for comments
RFID radio frequency identification
RLC radio link control
RRC radio resource control
RRH remote radio head
RU radio unit
Rx receiver
SDAP service data adaptation protocol
SEI supplemental enhancement information
SGD Stochastic Gradient Descent
SGW serving gateway
SMF session management function
SMS short messaging service
SPS sequence parameter set
st(v) null-terminated string encoded as UTF-8 characters as specified in ISO/IEC 10646
SVC scalable video coding
SI interface between eNodeBs and the EPC
TCP-IP transmission control protocol-internet protocol
TDMA time divisional multiple access
trak TrackBox
TS transport stream
TUC technology under consideration
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VPS video parameter set
WLAN wireless local area network
X2 interconnecting interface between two eNodeBs in LTE network
Xn interface between two NG-RAN nodes

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a bitstream with a ‘full’ frame rate;

FIG. 2 shows an example frame rate upsampling of the ‘full’ frame rate bitstream to a double frame rate;

FIG. 3 shows an example extracted bitstream for ‘half’ frame rate;

FIG. 4 shows frame rate upsampling of the ‘half’ frame rate bitstream to full frame rate;

FIG. 5 is an example apparatus to implement the examples described herein;

FIG. 6 shows a representation of an example of non-volatile memory media;

FIG. 7 is an example method to implement the examples described herein, in accordance with an embodiment;

FIG. 8 is an example method to implement the examples described herein, in accordance with another embodiment;

FIG. 9 is an example method to implement the examples described herein, in accordance with yet another embodiment;

FIG. 10 is an example method to implement the examples described herein, in accordance with still another embodiment;

FIG. 11 is an example method to implement the examples described herein, in accordance with still another embodiment;

FIG. 12 is an example method to implement the examples described herein, in accordance with still another embodiment;

FIG. 13 is an example method to implement the examples described herein, in accordance with still another embodiment;

FIG. 14 is an example method to implement the examples described herein, in accordance with still another embodiment;

FIG. 15 is an example method to implement the examples described herein, in accordance with still another embodiment;

FIG. 16 is an example method to implement the examples described herein, in accordance with still another embodiment; and

FIG. 17 shows a high level block diagram of various devices used in carrying out various features in accordance with various embodiments.

### DETAILED DESCRIPTION

In example embodiments of the invention there is proposed at least a method and an apparatus to select a frame rate upsampling filter and/or its input frames.

### Fundamentals of Neural Networks

A neural network (NN) is a computation graph including several layers of computation. Each layer includes one or more units, where each unit performs a computation. A unit is connected to one or more other units, and a connection may be associated with a weight. The weight may be used for scaling the signal passing through an associated connection. Weights are learnable parameters, for example, values which may be learned from training data. There may be other learnable parameters, such as those of batch-normalization layers.

Couple of examples of architectures for neural networks are feed-forward and recurrent architectures. Feed-forward neural networks are such that there is no feedback loop, each layer takes input from one or more of the previous layers and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in a supervised way or in an unsupervised way. Such learning is a result of a training algorithm, or of a meta-level neural network providing the training signal.

In general, the training algorithm includes changing some properties of the neural network so that its output is as close as possible to a desired output. For example, in the case of classification of objects in images, the output of the neural network may be used to derive a class or category index which indicates the class or category that the object in the input image belongs to. Training usually happens by minimizing or decreasing the output error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following:
when the network is learning at all—in this case, the training set error should decrease, otherwise the model is in the regime of underfitting.
when the network is learning to generalize—in this case, also the validation set error needs to decrease and be not too much higher than the training set error. For example, the validation set error should be less than 20% higher than the training set error. When the training set error is low, for example 10% of its value at the beginning of training, or with respect to a threshold that may have been determined based on an evaluation metric, but the validation set error is much higher than the training set error, or it does not decrease, or it even increases, the model is in the regime of overfitting. This means that the model has just memorized properties of the training set and performs well only on that set, but performs poorly on a set not used for training or tuning of its parameters.

Lately, neural networks have been used for compressing and de-compressing data such as images. The most widely used architecture for such task is the auto-encoder, which is a neural network including two parts: a neural encoder and a neural decoder. In various embodiments, these neural encoder and neural decoder would be referred to as encoder and decoder, even though these refer to algorithms which are learned from data instead of being tuned manually. The encoder takes an image as an input and produces a code, to represent the input image, which requires less bits than the input image. This code may have been obtained by a binarization or quantization process after the encoder. The decoder takes in this code and reconstructs the image which was input to the encoder.

Such encoder and decoder are usually trained to minimize a combination of bitrate and distortion, where the distortion may be based on one or more of the following metrics: mean squared error (MSE), peak signal-to-noise ratio (PSNR), structural similarity index measure (SSIM), or the like. These distortion metrics are meant to be correlated to the human visual perception quality, so that minimizing or maximizing one or more of these distortion metrics results into improving the visual quality of the decoded image as perceived by humans.

In various embodiments, terms ‘model’, ‘neural network’, ‘neural net’ and ‘network’ may be used interchangeably, and also the weights of neural networks may be sometimes referred to as learnable parameters or as parameters.

### Neural Network Representation (NNR)

ISO/IEC 15938-17 (Compression of Neural Networks for Multimedia Content Description and Analysis) is also known as neural network representation (NNR) or neural network compression (NNC). NNR specifies a compressed representation of the parameters and/or weights of a trained neural network and a decoding process for the compressed representation. NNR complements the description of the network topology in existing neural network exchange formats. NNR is independent of a particular neural network exchange format and is interoperable with common neural network exchange formats.

NNR establishes a toolbox of compression methods, specifying (where applicable) the resulting elements of the compressed bitstream. All of these tools may be applied to the compression of entire neural networks, and some of them may also be applied to the compression of differential updates of neural networks with respect to a base network. Such differential updates are, for example, useful when models are redistributed after fine-tuning or transfer learning, or when providing versions of a neural network with different compression ratios. The support for incremental compression of updates of neural networks respective to a base model will be included in the 2^{nd} edition of NNR, which is currently being standardized.

NNR comprises the syntax format, semantics, associated decoding process requirements, parameter sparsification, parameter transformation methods, parameter quantization, entropy coding method and integration/signaling within existing exchange formats.

An NNR bitstream may conform to ISO/IEC 15938-17. NNR bitstream or NNR data in a channel may comprise a sequence of NNR Units. An NNR Unit may be regarded as a basic high-level syntax structure in an NNR bitstream, and may include three syntax elements or structures: NNR Unit Size, NNR unit header, and NNR unit payload.

### Some Video Coding and Video Metadata Specifications

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

### Fundamentals of Video/Image Coding

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use may be indicated, e.g., in a coded bitstream e.g., using the Video Usability Information (VUI) syntax. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

Video codec includes an encoder that transforms the input video into a compressed representation suited for storage/transmission and a decoder that may decompress the compressed video representation back into a viewable form. Typically, an encoder discards some information in the original video sequence in order to represent the video in a more compact form, for example, at lower bitrate.

Typical hybrid video codecs, for example ITU-T H.263 and H.264, encode the video information in two phases. Firstly, pixel values in a certain picture area (or ‘block’) are predicted, for example, by motion compensation means or circuits (by finding and indicating an area in one of the previously coded video frames that corresponds closely to the block being coded) or by spatial means or circuit (by using the pixel values around the block to be coded in a specified manner). Secondly the prediction error, e.g., the difference between the predicted block of pixels and the original block of pixels, is coded. This is typically done by transforming the difference in pixel values using a specified transform (e.g., discrete cosine transform (DCT) or a variant of it), quantizing the coefficients and entropy coding the quantized coefficients. By varying the fidelity of the quantization process, the encoder may control the balance between the accuracy of the pixel representation (e.g., picture quality) and size of the resulting coded video representation (e.g., file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction may be performed in spatial or transform domain, for example, either sample values or transform coefficients may be predicted. Intra prediction is typically exploited in intra-coding, where no inter prediction is applied.

One outcome of the coding procedure is a set of coding parameters, such as motion vectors and quantized transform coefficients. Many parameters may be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain. After applying prediction and prediction error decoding techniques the decoder sums up the prediction and prediction error signals, for example, pixel values to form the output video frame. The decoder and encoder may also apply additional filtering techniques to improve the quality of the output video before passing it for display and/or storing it as prediction reference for the forthcoming frames in the video sequence.

Image and video codecs may use a set of filters, which may enhance the visual quality of the predicted visual content. Filters may be applied either in-loop or out-of-loop, or both. In-loop filters (which may be also called loop filters) are used in reconstructing prediction reference that may be used for predicting forthcoming video signal. In other words, in the case of in-loop filters, the filter applied on one block in the currently encoded frame may affect the encoding of another block in the same frame and/or in another frame which is predicted from the current frame. An in-loop filter may affect the bitrate and/or the visual quality. In fact, an enhanced block may cause a smaller residual (difference between original block and predicted-and-filtered block), thus requiring less bits to be encoded. An out-of-the loop filter (which may also be called a post-processing filter or a post-filter) may be applied on a frame or part of a frame after it has been reconstructed, the filtered visual content may not be used as a source for prediction, and thus it may only impact the visual quality of the frames that are output by the decoder.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures.

In order to represent motion vectors efficiently, the motion vectors are typically coded differentially with respect to block specific predicted motion vectors. In typical video codecs, the predicted motion vectors are created in a predefined way, for example, calculating the median of the encoded or decoded motion vectors of the adjacent blocks.

Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture may be predicted. The reference index is typically predicted from adjacent blocks and/or or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform may in many cases help reduce this correlation and provide more efficient coding.

Typical video encoders utilize Lagrangian cost functions to find optimal coding modes, for example, the desired macroblock mode and associated motion vectors. This kind of cost function uses a weighting factor λ to tie together the exact or estimated image distortion due to lossy coding methods and the exact or estimated amount of information that is required to represent the pixel values in an image area:

$$C = D + λ R \qquad equation 1$$

In equation 1, C is the Lagrangian cost to be minimized, D is the image distortion, for example, mean squared error with the mode and motion vectors considered, and R is the number of bits needed to represent the required data to reconstruct the image block in the decoder including the amount of data to represent the candidate motion vectors.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage may additionally or alternatively be used, e.g., for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) including coded video data.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such as boxes in the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload, when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some coding formats or standards, the end of a bitstream may be indicated by a specific NAL unit, which may be referred to as the end of bitstream (EOB) NAL unit and which is the last NAL unit of the bitstream.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266/VVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

A decoder and/or a hypothetical reference decoder (HRD) may comprise a picture output process. The output process may be considered to be a process in which the decoder provides decoded and cropped pictures as the output of the decoding process. The output process may be a part of video coding standards, e.g., as a part of the hypothetical reference decoder specification. In output cropping, lines and/or columns of samples may be removed from decoded pictures according to a cropping rectangle to form output pictures. A cropped decoded picture may be defined as the result of cropping a decoded picture based on the conformance cropping window specified, e.g., in the sequence parameter set that is referred to by the corresponding coded picture. Hence, it may be considered that the conformance cropping window specifies the cropping rectangle to form output pictures from decoded pictures.

In VVC, pps_pic_width_in_luma_samples specifies the width of each decoded picture referring to the PPS in units of luma samples. pps_pic_height_in_luma_samples specifies the height of each decoded picture referring to the PPS in units of luma samples.

In VVC, pps_conf_win_left_offset, pps_conf_win_right_offset, pps_conf_win_top_offset, and pps_conf_win_bottom_offset specify the conformance cropping window, e.g., the samples of the picture that are output from the decoding process, in terms of a rectangular region specified in picture coordinates for output. pps_conf_win_left_offset indicates the number of sample columns outside the conformance cropping window at the left edge of the decoded picture. pps_conf_win_right_offset indicates the number of sample columns outside the conformance cropping window at the right edge of the decoded picture. pps_conf_win_top_offset indicates the number of sample columns outside the conformance cropping window at the top edge of the decoded picture. pps_conf_win_bottom_offset indicates the number of sample columns outside the conformance cropping window at the bottom edge of the decoded picture. In VVC, pps_conf_win_left_offset, pps_conf_win_right_offset, pps_conf_win_top_offset, and pps_conf_win_bottom_offset use a unit of a single luma sample in monochrome (4:0:0) and 4:4:4 chroma formats, a unit of 2 luma samples in the 4:2:0 chroma format, and a unit of 2 luma samples is used for pps_conf_win_left_offset and pps_conf_win_right_offset, and a unit of 1 luma sample for pps_conf_win_top_offset and pps_conf_win_bottom_offset in the 4:2:2 chroma format.

Video coding specifications may enable the use of supplemental enhancement information (SEI) messages or alike. Some video coding specifications include SEI NAL units, and some video coding specifications include both prefix SEI NAL units and suffix SEI NAL units, where the former type may start a picture unit or alike and the latter type may end a picture unit or alike. An SEI NAL unit includes one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may include the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications may require the use of particular SEI messages both in the encoding end and in the decoding end, and additionally the process for handling particular SEI messages in the recipient may be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance. The variable including a POC value of a picture may be referred to as PicOrderCntVal.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de) coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have _idc postfix in its name.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

### Neural-Network Post-Filter Characteristics (NNPFC) and Neural-Network Post-Filter Activation (NNPFA) SEI Messages

The neural-network post-filter characteristics (NNPFC) SEI message and the neural-network post-filter activation (NNPFA) SEI message have been described in document N0158 of ISO/IEC JTC1 SC29 WG05.

The neural-network post-filter characteristics (NNPFC) SEI message specifies a neural network that may be used as a post-processing filter. The use of specified post-processing filters for specific pictures is indicated with neural-network post-filter activation SEI messages.

The NNPFC SEI message may be specified through at least some of the following variables, which may be derived from the bitstream included the NNPFC SEI message:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics−1, inclusive, that are used as input for the post-processing filter.
Bit depth BitDepthy for the luma sample array of the cropped decoded output pictures.
Bit depth BitDepthc for the chroma sample arrays, if any, of the cropped decoded output pictures.
A chroma format indicator, denoted herein by ChromaFormatIdc.
A filtering strength control value StrengthControlVal, which may be a real number in the range of 0 to 1, inclusive.

The variables SubWidthC and SubHeightC may be derived from ChromaFormatIdc. For monochrome and 4:4:4 chroma formats, SubWidthC and SubHeightC are both equal to 1. For 4:2:0 chroma format, SubWidthC and SubHeightC are both equal to 2. For 4:2:2 chroma format, SubWidthC is equal to 2 and SubHeightC is equal to 1.

The NNPFC SEI message comprises the nnpfc_id syntax element, which includes an identifying number that may be used to identify a post-processing filter. A base post-processing filter is the filter that is included in or identified by the first NNPFC SEI message, in decoding order, that has a particular nnpfc_id value within a coded layer video sequence (CLVS). When there is a second NNPFC SEI message that has the same nnpfc_id value that defines the base post-processing filter, an update relative to the base post-processing filter is applied to obtain a post-processing filter associated with the nnpfc_id value. The update may be obtained by decoding the coded neural network bitstream in the second NNPFC SEI message. Otherwise, the post-processing filter associated with the nnpfc_id value is assigned to be the same as the base post-processing filter.

The NNPFC SEI message comprises nnpfc_mode_idc syntax element, the semantics of which may be defined as follows:
nnpfc_mode_idc equal to 0 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.
nnpfc_mode_idc equal to 1 indicates that this SEI message includes an ISO/IEC 15938-17 bitstream that specifies the base post-processing filter or updates relative to the base post-processing filter with the same nnpfc_id value.

The NNPFC SEI message may also comprise:
Purpose of the post-processing filter (nnpfc_purpose), for example:
   Determined by the application (nnpfc_purpose equal to 0)
   Visual quality improvement (nnpfc_purpose equal to 1)
   Chroma upsampling from the 4:2:0 chroma format to the 4:2:2 or 4:4:4 chroma format, or from the 4:2:2 chroma format to the 4:4:4 chroma format (nnpfc_purpose equal to 2)
   Increasing the width or height of the cropped decoded output picture without changing the chroma format (nnpfc_purpose equal to 3)
   Increasing the width or height of the cropped decoded output picture and upsampling the chroma format (nnpfc_purpose equal to 4)
   Frame rate upsampling (nnpfc_purpose equal to 5)
Formatting of the input tensors that are given as input to the neural network inference
Formatting of the output tensors that are resulting from the neural network inference
Characterization of the complexity of the neural network

The NNPFA SEI message specifies the neural-network post-processing filter that may be used for post-processing filtering for the current picture, or for post-processing filtering for the current picture and one or more other pictures. The NNPFA SEI message comprises the nnpfa_target_id syntax element, which indicates that the neural-network post-processing filter with nnpfc_id equal to nnfpa_target_id may be used for post-processing filtering for the indicated persistence. The indicated persistence may be the current picture only (nnpfa_persistence_flag equal to 0), or until the end of the current coded layer video sequence (CLVS) or the next picture, in output order, in the current layer associated with a NNPFA SEI message with the same nnpfa_target_id as the current SEI message (nnpfa_persistence_flag equal to 1).

Increasing the width or height of the cropped decoded output picture without changing the chroma format may also be referred to as super resolution, super resolution filtering, or spatial upsampling.

Frame rate upsampling (which may also be referred to as picture rate upsampling or temporal upsampling) may refer to a process of generating frames between frames given as input to the process. As a consequence, the frame rate may increase compared to the frame rate of the input frames. Frame rate upsampling may be performed, for example, by a motion-compensated frame interpolation method or by a neural network.

### Frame Packing

Frame packing may be defined to comprise arranging more than one input picture, which may be referred to as (input) constituent frames, into an output picture, or arranging the input pictures as a temporal interleaving of alternating first and second constituent frames.

A constituent frame parity may be defined as a first constituent frame or a second constituent frame, or equivalent as constituent frame 0 or constituent frame 1.

In general, frame packing is not limited to any particular type of constituent frames or the constituent frames need not have a particular relation with each other. In many cases, frame packing is used for arranging constituent frames of a stereoscopic video clip into a single picture sequence, as explained in more details in the next paragraph. The arranging may include placing the input pictures in spatially non-overlapping areas within the output picture. For example, in a side-by-side arrangement, two input pictures are placed within an output picture horizontally adjacently to each other. The arranging may also include partitioning of one or more input pictures into two or more constituent frame partitions and placing the constituent frame partitions in spatially non-overlapping areas within the output picture. The output picture or a sequence of frame-packed output pictures may be encoded into a bitstream e.g., by a video encoder. The bitstream may be decoded e.g., by a video decoder. The decoder or a post-processing operation after decoding may extract the decoded constituent frames from the decoded picture(s) e.g., for displaying.

In frame-compatible stereoscopic video (a.k.a. frame packing of stereoscopic video), a spatial packing of a stereo pair into a single frame is performed at the encoder side as a pre-processing step for encoding and then the frame-packed frames are encoded with a conventional 2D video coding scheme. The output frames produced by the decoder includes constituent frames of a stereo pair.

In a typical operation mode, the spatial resolution of the original frames of each view and the packaged single frame have the same resolution. In this case the encoder downsamples the two views of the stereoscopic video before the packing operation. The spatial packing may use for example a side-by-side or top-bottom format, and the downsampling need to be performed accordingly.

An encoder may indicate the use of frame packing by including one or more frame packing arrangement SEI messages, e.g., as defined in VSEI, in the bitstream. Likewise, a decoder may conclude the use of frame packing by decoding one or more frame packing arrangement SEI messages from the bitstream. When a frame packing arrangement SEI message applies to the CLVS, a cropped decoded picture includes samples of multiple distinct spatially packed constituent frames that are packed into one frame, or that the output cropped decoded pictures in output order form a temporal interleaving of alternating first and second constituent frames, using an indicated frame packing arrangement scheme. This information may be used by the decoder to appropriately rearrange the samples and process the samples of the constituent frames appropriately for display or other purposes.

In some video codecs, video usability information (VUI) may be included in a sequence parameter set (SPS). VUI specified in VSEI comprises the following:
vui_non_packed_constraint_flag equal to 1 specifies that there may not be any frame packing arrangement SEI messages present in the bitstream that apply to the CLVS. vui_non_packed_constraint_flag equal to 0 does not impose such a constraint.

### SEI Processing Order SEI Message

The SEI processing order SEI message has been described, for example, in document JVET-AA2027. The SEI processing order SEI message carries information indicating a preferred processing order, as determined by the encoder (e.g., the content producer), for different types of SEI messages that may be present in the bitstream. When an SEI processing order SEI message is present, it is present in the first access unit of the coded video sequence. The SEI processing order SEI message persists in decoding order from the current access unit until the end of the CVS. The SEI processing order SEI message comprises a list of pairs, each pair comprising a SEI payload type po_sei_payload_type[i] a value and processing order value po_sei_processing_order[i]. po_sei_payload_type[i] specifies a value of payloadType for the i-th SEI message for which information is provided in the SEI processing order SEI message. po_sei_processing_order[i] indicates the preferred order of processing any SEI message with payloadType equal to po_sei_payload_type[i]. po_sei_processing_order[m] greater than 0 and less than po_sei_processing_order[n] indicates any SEI message with payloadType equal to po_sei_payload_type[m], when present, should be processed before any SEI message with payloadType equal to po_sei_payload_type[n]. po_sei_processing_order[m] greater than 0 and equal to po_sei_processing_order[n] indicates that the preferred order of processing of SEI messages with payloadTypes equal to po_sei_payload_type[m] and po_sei_payload_type[n] is unknown, unspecified, or determined by external means. po_sei_processing_order[i] equal to 0 specifies that the preferred order of processing SEI messages with payloadType equal to po_sei_payload_type[i] is unknown, unspecified, determined by external means.

### ISO Base Media File Format

Available media file format standards include ISO base media file format (ISO/IEC 14496-12, which may be abbreviated ISOBMFF) and the file format for NAL unit structured video (ISO/IEC 14496-15), which derives from the ISOBMFF.

Some concepts, structures, and specifications of ISOBMFF are described below as an example of a container file format, based on which some embodiments may be implemented. The features of the disclosure are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO family of file formats, a file includes media data and metadata that are encapsulated into boxes. Each box is identified by a four character code (4CC) and starts with a header which informs about the type and size of the box.

In files conforming to the ISO base media file format, the media data may be provided in a media data box (‘mdat’, also called MediaDataBox) and the movie box (‘moov’, also called MovieBox) may be used to enclose the metadata. In some examples, for a file to be operable, both of the ‘mdat’ and ‘moov’ boxes may be required to be present. The movie box may include one or more tracks, and each track may reside in one corresponding track box (‘trak’, may also be called TrackBox). A track may be one of the many types, including a media track that refers to samples formatted according to a media compression format (and its encapsulation to the ISO base media file format).

The ‘trak’ box includes a Sample Table box. The Sample Table box includes, for example, time and data indexing of the media samples in a track. The Sample Table box is required to include a Sample Description box. The Sample Description box includes an entry count field, specifying the number of sample entries included in the box. The Sample Description box is required to include at least one sample entry. The sample entry format depends on the handler type for the track. Sample entries give detailed information about the coding type used and any initialization information needed for that coding.

Movie fragments may be used, for example, when recording content to ISO files, for example, in order to avoid losing data when a recording application crashes, runs out of memory space, or some other incident occurs. Without movie fragments, data loss may occur because the file format may require that all metadata, for example, the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, for example, simultaneous reception and playback of a file when movie fragments are used, and the initial movie box is smaller compared to a file with the same media content but structured without movie fragments.

A movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited, and the use cases mentioned above be realized.

A MovieBox may include a MovieExtendsBox (‘mvex’). When present, presence of the MovieExtendsBox warns readers that there might be movie fragments in this file or stream. To know of all samples in the tracks, movie fragments are obtained and scanned in order, and their information logically added to information in the MovieBox. A MovieExtendsBox includes one TrackExtendsBox per track. A TrackExtendsBox includes default values used by the movie fragments. Some examples of the default values that can be given in TrackExtendsBox, include but are not limited to: default sample description index (e.g., default sample entry index), default sample duration, default sample size, and default sample flags. Sample flags include dependency information, such as when the sample depends on other sample(s), when other sample(s) depend on the sample, and when the sample is a sync sample.

In some examples, the media samples for the movie fragments may reside in an mdat box, when the movie fragments are in the same file as the moov box. For the metadata of the movie fragments, however, a moof box (also called MovieFragmentBox) may be provided. The moof box may include information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track. Within these structures, many fields are optional and may have default values. The metadata that may be included in the moof box may be limited to a subset of the metadata that may be included in a moov box and may be coded differently in some cases. Details regarding the boxes that can be included in a moof box may be found from the ISO base media file format specification.

The track reference mechanism may be used to associate tracks with each other. The TrackReferenceBox includes box(es), each of which provides a reference from the including track to a set of other tracks. These references are labeled through the box type (e.g., the four-character code of the box) of the included box(es).

In ISOBMFF, a track group enables grouping of tracks based on certain characteristics or the tracks within a group have a particular relationship. Track grouping, however, does not allow any image items in the group. A track group box (also known as TrackGroupBox) may be present in a TrackBox and may include boxes that are derived from TrackGroupTypeBox, which is a box whose box payload starts with track_group_id and whose box type (also referred to as track_group_type) defines the track group type.

The pair of track_group_id and track_group_type identifies a track group within a file. The tracks that include a particular TrackGroupTypeBox having the same value of track_group_id and track_group_type belong to the same track group.

The TrackGroupDescriptionBox may be included in the MovieBox. The TrackGroupDescriptionBox provides an array of TrackGroupEntryBoxes, where each TrackGroupEntryBox provides detailed characteristics of a particular track group. The syntax of the TrackGroupEntryBox is determined by track_group_entry_type. TrackGroupEntryBox is mapped to the track group by a unique track_group_entry_type that is associated with a track_group_type. More than one TrackGroupEntryBox with the same track_group_entry_type and different track_group_id may be present in TrackGroupDescriptionBox.

A sample grouping in the ISO base media file format and its derivatives may be defined as an assignment of each sample in a track to be a member of one sample group, based on a grouping criterion. A sample group in a sample grouping is not limited to being contiguous samples and may include non-adjacent samples. As there may be more than one sample grouping for the samples in a track, each sample grouping may have a type field grouping_type to indicate the type of grouping. Sample groupings may be represented by two linked data structures: (1) a Sample ToGroupBox (‘sbgp’ box) represents the assignment of samples to sample groups; and (2) a SampleGroupDescriptionBox (‘sgpd’ box) includes sample group (description) entries for describing the properties of samples mapped to this entry. There may be multiple instances of the SampleToGroupBox and SampleGroupDescriptionBox based on different grouping criteria. These may be distinguished by a type field used to indicate the type of grouping. SampleToGroupBox may additionally comprise a grouping_type_parameter field that can be used e.g., to indicate a sub-type of the grouping.

An essential sample group description is a sample group description for which the version field is equal to 3, and the associated sample group is also referred to as an essential sample group. An essential sample group description describes essential information for the associated samples, and parsers are not allowed to attempt to process any track for which unrecognized sample group descriptions marked as essential are present.

### Neural-Network Post-Filter Sample Groups

Preliminary working draft of ISO/IEC 14496-15 6th Edition, Amendment 3 (ISO/IEC JTC 1/SC 29/WG 03 document N0748) specifies neural-network post-filter characteristics (NNPFC) and neural-network post-filter activation sample groups.

Instances of the SampleToGroupBox for the NNPFC sample group include grouping_type_parameter. The grouping_type_parameter field is specified for the NNPFC sample group as follows:

```
{
  unsigned int(1) filter_update_flag;
  unsigned int(31) filter_id;
}
```

filter_update_flag equal to 1 indicates that all the sample group description entries referenced by this SampleToGroupBox include an NNPFC SEI message that provides an update on top of a base post-processing filter. filter_update_flag equal to 0 indicates that all the sample group description entries referenced by this SampleToGroupBox include an NNPFC SEI message that specifies a base post-processing filter.
filter_id indicates that all the sample group description entries referenced by this SampleToGroupBox include an NNPFC SEI message that has nnpfc_id equal to filter_id.

As a consequence of the grouping_type_parameter definition, the post-processing filters for different nnpfc_id values are specified in different instances of the SampleToGroupBox. Furthermore, one SampleToGroupBox specifies the base post-processing filter(s) for a particular nnpfc_id value, while another SampleToGroupBox, if any, specifies the filter updates for the same nnpfc_id value. It is therefore possible to indicate that the base post-processing filter persists over a longer period than any of the filter updates.

When a sample is not mapped to NnpfcSeiEntry in a SampleToGroupBox having filter_update_flag equal to 0 and a particular filter_id, the sample is not be mapped to an NnpfcSeiEntry in a SampleToGroupBox having filter_update_flag equal to 1 and the same filter_id.

A sample group description entry of the NNPFC sample group (e.g., NnpfcSeiEntry) includes an NNPFC SEI message.

A sample group description entry of the NNPFA sample group (e.g., NnpfaSeiEntry) includes an NNPFC SEI message.

A reader may support the NNPFA sample group by performing the following implicit insertion of prefix SEI NAL units as a part of the bitstream reconstruction: When a sample is mapped to at least one NnpfaSeiEntry, the sample implicitly includes a prefix SEI NAL unit for each layer included in the track, and the prefix SEI NAL unit includes the NNPFA SEI message from the NnpfaSeiEntry.

Interaction with Temporal Interleaving Frame Packing Arrangement

The frame packing arrangement SEI message indicates, when fp_arrangement_type is equal to 5, that first and second constituent frames (usually, the left- and right-view pictures of the same time) are temporally interleaved. When a frame rate upsampling post-filter is applied with temporal frame packing arrangement, using the current frame (where the post-filter is activated) and one or more previous frames in output order as input to the post-filter results into constituent frames of different ‘parities’ being used as input for post-filtering. This is likely to make the output of the post-filter unpredictable.

### Varying Picture Width and Height in Input Pictures

In some video codecs, such as VVC, the width and height of pictures may vary within a CLVS. However, the NNPFC SEI message semantics assume that all input pictures have the same width and height, since the NNPFC SEI message semantics inputs one pair of CroppedWidth and CroppedHeight values.

Interaction with Temporal Scalability

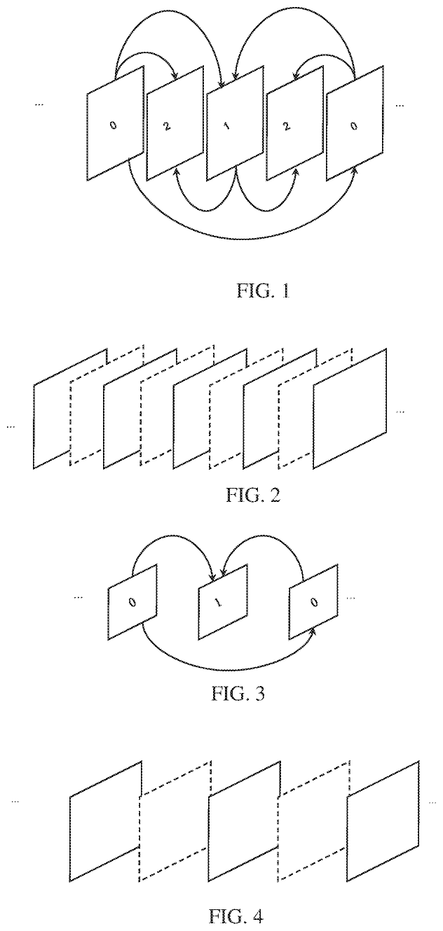

FIG. 1 shows a bitstream with a ‘full’ frame rate. FIG. 1 indicates some pictures in output order with their TemporalId value enclosed in the corresponding pictures and potential prediction dependencies indicated by prediction arrows.

FIG. 2. shows an example frame rate upsampling of the ‘full’ frame rate bitstream to a double frame rate. When a neural-network post-filter for interpolating one picture (as indicated by pictures with dashed-line boundaries) between a pair of adjacent pictures in output order is applied to the example sequence of FIG. 1, the interpolated pictures as shown in FIG. 2 are obtained.

FIG. 3. shows an example extracted bitstream for ‘half’ frame rate. When pictures of TemporalId equal to 2 are removed from the bitstream of FIG. 1, the resulting bitstream may be illustrated as shown in FIG. 3.

FIG. 4 shows frame rate upsampling of the ‘half’ frame rate bitstream to full frame rate. When a neural-network post-filter for interpolating one picture (as indicated by pictures with dashed-line boundaries) between a pair of adjacent pictures in output order is applied to the example sequence without TemporalId equal to 2, the interpolated pictures as shown in FIG. 4 are obtained:

Some example issues related to applying neural-network post-filtering for frame rate upsampling include:
NN post-filters may be trained for a certain frame rate and might therefore be suboptimal when used for another frame rate.
Frame rate upsampling may be unsatisfactory when the frame rate of the input pictures is too low.

In an example, it is suggested that the use of neural-network post-filter for frame rate upsampling should be controllable by an encoder, as follows, depending on the temporal operation point in use in decoding:
It should be possible for the encoder to indicate that no frame rate upsampling should be performed when the temporal operation point is below a limit indicated by the encoder. For example, referring to the example above, the encoder may conclude and indicate that no frame rate upsampling ought to be performed for a sub-bitstream of that includes only pictures with TemporalId equal to 0.
when more than one frame rate upsampling post-filter is defined for the bitstream, it should be possible for the encoder to indicate a selection which one of them is in use based on the temporal operation point in use. For example, the encoder may define a first frame rate upsampling post-filter for the ‘full’ frame rate used in the example above, and a second frame rate upsampling post-filter to be used for a sub-bitstream that includes pictures with TemporalId equal to 0 or 1 (e.g., ‘half’ frame rate).

Various embodiments define input frames to be used for a frame rate upsampling post-filter for the following example cases:
temporal interleaving frame packing arrangement is in use; and/or
pictures in a CLVS have different widths and/or heights.

Various embodiments also enable signaling of multiple frame rate upsampling post-filters applicable to different frame rates and enables indicating which frame rate upsampling post-filter is to be applied when temporal sublayer based sub-bitstream extraction has taken place prior to decoding.

Interaction with Temporal Interleaving Frame Packing Arrangement

In an embodiment, a decoder:
concludes that temporal interleaving frame packing arrangement is in use in a bitstream, e.g., from a frame packing arrangement SEI message or alike;
concludes a constituent frame parity that a current frame where a frame rate upsampling post-filter is activated has for the temporal interleaving frame packing arrangement;
selects input frames for the frame rate upsampling post-filter that have the concluded constituent frame parity; and
applies the frame rate upsampling post-filter with the input frames as input.

In an embodiment, let currCodedPic be the coded picture in which the post-processing filter defined by the NNPFC SEI message is activated by an NNPFA SEI message and numInputPics be the number of input pictures for the post-processing filter. The array inputPicPoc[i] for all values of i in the range of 0 to numInputPics−1, inclusive, specifying the picture order count values for the input pictures for the post-processing filter, is derived as follows:
inputPicPoc[0] is set equal to PicOrderCntVal of currCodedPic.
The following applies for each value of i in the range of 1 to numInputPics−1, inclusive, in increasing order of i:
   When currPic includes a constituent frame X (X being either 0 or 1) in temporal interleaving frame packing arrangement, inputPicPoc[i] is set equal to PicOrderCntVal of the picture that precedes, in output order, the picture associated with index i−1 and includes a constituent frame X.
   Otherwise (currPic does not include a constituent frame in temporal interleaving frame packing arrangement), inputPicPoc[i] is set equal to PicOrderCntVal of the picture that precedes, in output order, the picture associated with index i−1.
The luma sample arrays CroppedYPic[i] and the chroma sample arrays CroppedCbPic[i] and CroppedCrPic[i], when present, are derived as follows for each value of i in the range of 0 to numInputPics−1, inclusive, to be the of the Y, Cb and Cr components, respectively, of the picture with PicOrderCntVal equal to inputPicPoc[i] in the CLVS including the currCodedPic.

In an embodiment, a decoder:
concludes that temporal interleaving frame packing arrangement is in use in a bitstream, e.g., from a frame packing arrangement SEI message or alike;
selects input frames for the frame rate upsampling post-filter; and
applies the frame rate upsampling post-filter with the input frames and information indicative of the temporal interleaving frame packing arrangement as inputs.

In an embodiment, the decoder may further:
conclude a constituent frame parity for each input frame for the temporal interleaving frame packing arrangement; and
provide the constituent frame parity for each input frame as input when applying the frame rate upsampling post-filter.

In an alternative embodiment, the decoder may further:
conclude a constituent frame parity that a current frame where a frame rate upsampling post-filter is activated has for the temporal interleaving frame packing arrangement; and
provide the constituent frame parity for the current frame as input when applying the frame rate upsampling post-filter.

In this embodiment, when the frame rate upsampling post-filter receives a constituent frame parity as input, the decoder may assume that the other input frames have alternating constituent frame parities.

In some embodiments, it may be assumed in the frame rate upsampling post-filter that the current frame being constituent frame 0 indicates that the previous input frame is constituent frame 1 of a different timestamp.

In some embodiments, it may be assumed in the frame rate upsampling post-filter that the current frame being constituent frame 1 indicates that the previous input frame is constituent frame 0 of the same timestamp.

### Varying Picture Width and Height in Input Pictures

In an embodiment, a decoder:
applies a frame rate upsampling filter to two or more input frames that may have different widths and heights, wherein the widths and heights of the input frames are given as input the frame rate upsampling filter.

In an embodiment, an encoder:
signals that a frame rate upsampling filter is applicable with two or more input frames as input; and
constraints the two or more input frames to have the same widths and heights.

According to an example summary of the embodiment, all input pictures to the frame rate upsampling filter have the same dimensions.

In an embodiment, an encoder:
signals that a super resolution filter is applicable to one or more frames; and
signals that a frame rate upsampling filter is applicable with two or more input frames as input, wherein the two or more frames may be partly or completely the same as the one or more frames and wherein the two or more frames have the same widths and heights subsequent to applying the super resolution filter to the one or more frames.

According to an example summary of the embodiment, all input pictures to the frame rate upsampling filter have the same dimensions after applying super resolution post-filter applicable to the input pictures, when signaled.

In an embodiment, a decoder:
concludes that a super resolution filter is applicable to one or more frames;
concludes that a frame rate upsampling filter is applicable with two or more input frames as input, wherein the two or more frames may be partly or completely the same as the one or more frames;
applies the super resolution filter to the one or more frames to obtain two or more equal-resolution input frames; and
applies the frame rate upsampling filter to the two or more equal-resolution input frames.

In an embodiment, a decoder may further:
conclude to apply the super resolution filter, when the input frame to the super resolution filter would otherwise have an incompatible width or height to be an input to the frame rate upsampling filter of the two or more input frames.

In an embodiment, a decoder:
concludes that a frame rate upsampling filter is applicable with two or more equal-resolution input frames as input;
selects a current frame where the frame rate upsampling post-filter is activated to be among the two or more equal-resolution input frames;
selects one or more other frames that precede the current frame and have the same width and height as those of the current frame to be among the two or more equal-resolution input frames; and
applies the frame rate upsampling filter to the two or more equal-resolution input frames.

In an embodiment, an encoder:
signals that a super resolution filter is applicable to one or more frames;
signals that a frame rate upsampling filter is applicable with two or more input frames as input,
signals a processing order between a super resolution filter and a frame rate upsampling filter, wherein the processing order applies to an intersection of the two or more frames and the one or more frames and the processing order is such that the input frames to the frame rate upsampling filter have the same widths and heights.

In an embodiment, an encoder includes the type value (e.g., the SEI message type of the NNPFC SEI message) and the first identifier value (e.g., the nnpfc_id value of a frame rate upsampling filter) as well as the type value (e.g., the SEI message type of the NNPFC SEI message) and the second identifier value (e.g., the nnpfc_id value of a super resolution filter) in a processing order indication, such as in a SEI processing order SEI message, to indicate the respective processing order of the frame rate upsampling filter and the super resolution filter. In an embodiment, a decoder decodes the type value and the first identifier value as well as the type value and the second identifier value from a processing order indication, such as from a SEI processing order SEI message, to determine the respective processing order of the frame rate upsampling filter and the super resolution filter.

### EXAMPLE EMBODIMENT

The following example implementation realizes one or more embodiments described above in relation to the semantics of NNPFC SEI message when the post-processing filter defined of the NNPFC SEI message(s) is activated by an NNPFA SEI message. It is to be understood that other embodiments may be realized as presented in this example.

Let currCodedPic be the coded picture in which the post-processing filter defined by the NNPFC SEI message is activated by an NNPFA SEI message.

The variables currPic, specifying the picture to which the post-processing filter is applied, currWidth, specifying the width of the picture to which the post-processing filter is applied in luma samples, and currHeight, specifying the height of the picture to which the post-processing filter is applied in lumas samples, are derived as follows:
When nnpfc_purpose is equal to 5 and there is a post-processing filter that is defined by at least one NNPFC SEI message, is activated by an NNPFA SEI message for currCodedPic, and has nnpfc_purpose equal to 3, the following applies:
   currPic is set to be the output of the neural-network inference of the post-processing filter with the cropped decoded output picture corresponding to currCodedPic as an input.
   currWidth is set equal to nnpfc_pic_width_in_luma_samples.
   currHeight is set equal to nnpfc_pic_height_in_luma_samples.
Otherwise, the following applies:
   currPic is the cropped decoded output picture corresponding to currCodedPic.
   currWidth is set equal to pps_pic_width_in_luma_samples−SubWidthC*(pps_conf_win_left_offset+pps_conf_win_right_offset) applying to currCodedPic.
   currHeight is set equal to pps_pic_height_in_luma_samples−SubHeightC*(pps_conf_win_top_offset+pps_conf_win_bottom_offset) applying to currCodedPic.

When nnpfc_purpose is equal to 5, the variables numInputPics, specifying the number of input pictures for the post-processing filter, and the array inputPicPoc[i] for all values of i in the range of 0 to numInputPics−1, inclusive, specifying the picture order count values for the input pictures for the post-processing filter, are derived as follows:
The variable numInputPics is set equal to nnpfc_num_input_pics_minus2+2.
The variable inputPicPoc[i] for all values of i in the range of 0 to numInputPics−1, inclusive, is derived as follows:
   inputPicPoc[0] is set equal to PicOrderCntVal of currCodedPic.
   The following applies for each value of i in the range of 1 to numInputPics−1, inclusive, in increasing order of i:
      when currPic includes a constituent frame X (X being either 0 or 1) in temporal interleaving frame packing arrangement, inputPicPoc[i] is set equal to PicOrderCntVal of the picture that precedes, in output order, the picture associated with index i−1 and includes a constituent frame X.
      Otherwise (currPic does not include a constituent frame in temporal interleaving frame packing arrangement), inputPicPoc[i] is set equal to PicOrderCntVal of the picture that precedes, in output order, the picture associated with index i−1.

For purposes of interpretation of the NNPFC SEI message, the following variables are specified:
CroppedWidth is set equal to currWidth.
CroppedHeight is set equal to currHeight.
The luma sample array CroppedYPic[0] and the chroma sample arrays CroppedCbPic[0] and CroppedCrPic[0], when present, are set to be the 2-dimensional arrays of decoded sample values of the Y, Cb and Cr components, respectively, of currPic.
When nnpfc_purpose is equal to 5, the luma sample arrays CroppedYPic[i] and the chroma sample arrays CroppedCbPic[i] and CroppedCrPic[i], when present, are derived as follows for each value of i in the range of 1 to numInputPics−1, inclusive:
   Let sourcePic be the cropped decoded output picture that has PicOrderCntVal equal to inputPicPoc[i] in the CLVS including currCodedPic.
   The variable sourceWidth is set equal to pps_pic_width_in_luma_samples−SubWidthC*(pps_conf_win_left_offset+pps_conf_win_right_offset) applying to sourcePic.
   The variable sourceHeight is set equal to pps_pic_height_in_luma_samples−SubHeightC*(pps_conf_win_top_offset+pps_conf_win_bottom_offset) applying to sourcePic.
   When sourceWidth is equal to CroppedWidth and souceHeight is equal to CroppedHeight, inputPic is set to be the same as sourcePic.
   Otherwise (sourceWidth is not equal to CroppedWidth or souceHeight is not equal to CroppedHeight), the following applies:
      There may be a post-processing filter, hereafter referred to as the super resolution filter, that is defined by at least one NNPFC SEI message, is activated by an NNPFA SEI message for sourcePic, and has nnpfc_purpose equal to 3, nnpfc_pic_width_in_luma_samples equal to CroppedWidth and nnpfc_pic_height_in_luma_samples equal to CroppedHeight.
      inputPic is set to be the output of the neural-network inference of the super resolution filter with sourcePic being an input.
   The luma array CroppedYPic[i] and the chroma sample arrays CroppedCbPic[i] and CroppedCrPic[i], when present, are set to be the 2-dimensional arrays of decoded sample values of the Y, Cb and Cr components, respectively, of inputPic.
BitDepthy and BitDepthc are both set equal to BitDepth.
ChromaFormatIdc is set equal to sps_chroma_format_idc.
StrengthControlVal is set equal to the value of SliceQpy÷63 of the first slice of currCodedPic.

### EXAMPLE EMBODIMENT

The following example implementation realizes one or more embodiments described above in relation to the semantics of NNPFC SEI message when the post-processing filter defined of the NNPFC SEI message(s) is activated by an NNPFA SEI message. It is to be understood that other embodiments could be realized as presented in this example.

Let currCodedPic be the coded picture in which the post-processing filter defined by the NNPFC SEI message is activated by an NNPFA SEI message.

When nnpfc_purpose is equal to 5, the variables numInputPics, specifying the number of input pictures for the post-processing filter, and the array inputPicPoc[i] for all values of i in the range of 0 to numInputPics−1, inclusive, specifying the picture order count values for the input pictures for the post-processing filter, are derived as follows:
The variable numInputPics is set equal to nnpfc_num_input_pics_minus2+2.
The variable inputPicPoc[i] for all values of i in the range of 0 to numInputPics−1, inclusive, is derived as follows:
   inputPicPoc[0] is set equal to PicOrderCntVal of currCodedPic.
   The following applies for each value of i in the range of 1 to numInputPics−1, inclusive, in increasing order of i:
      When currPic includes a constituent frame X (X being either 0 or 1) in temporal interleaving frame packing arrangement, inputPicPoc[i] is set equal to PicOrderCntVal of the picture that precedes, in output order, the picture associated with index i−1 and includes a constituent frame X.
   Otherwise (currPic does not include a constituent frame in temporal interleaving frame packing arrangement), inputPicPoc[i] is set equal to PicOrderCntVal of the picture that precedes, in output order, the picture associated with index i−1.

For purposes of interpretation of the NNPFC SEI message, the following variables are specified:
CroppedWidth is set equal to pps_pic_width_in_luma_samples−SubWidthC*(pps_conf_win_left_offset+pps_conf_win_right_offset) applying to currCodedPic.
CroppedHeight is set equal to pps_pic_height_in_luma_samples−SubHeightC*(pps_conf_win_top_offset+pps_conf_win_bottom_offset) applying to currCodedPic.
The luma sample array CroppedYPic[0] and the chroma sample arrays CroppedCbPic[0] and CroppedCrPic[0], when present, are set to be the 2-dimensional arrays of decoded sample values of the Y, Cb and Cr components, respectively, of currPic.
When nnpfc_purpose is equal to 5, the luma sample arrays CroppedYPic[i] and the chroma sample arrays CroppedCbPic[i] and CroppedCrPic[i], when present, are derived as follows for each value of i in the range of 1 to numInputPics−1, inclusive:
   Let inputPic be the cropped decoded output picture that has PicOrderCntVal equal to inputPicPoc[i] in the CLVS including currCodedPic.
   It is a requirement of bitstream conformance that pps_pic_width_in_luma_samples−SubWidthC*(pps_conf_win_left_offset+pps_conf_win_right_offset) applying to inputPic is equal to CroppedWidth.
   It is a requirement of bitstream conformance that pps_pic_height_in_luma_samples−SubHeightC*(pps_conf_win_top_offset+pps_conf_win_bottom_offset) applying to inputPic is equal to CroppedHeight.
   The luma array CroppedYPic[i] and the chroma sample arrays CroppedCbPic[i] and CroppedCrPic[i], when present, are set to be the 2-dimensional arrays of decoded sample values of the Y, Cb and Cr components, respectively, of inputPic.
BitDepthy and BitDepthc are both set equal to BitDepth.
ChromaFormatIdc is set equal to sps_chroma_format_idc.
StrengthControlVal is set equal to the value of SliceQpy÷63 of the first slice of currCodedPic.
   Interaction with Temporal Scalability

In an embodiment, an NNPFC SEI message defining a frame rate upsampling filter is appended to be indicative of a range of TemporalId values. When a sub-bitstream is extracted with the highest TemporalId value in the sub-bitstream being any value within the range of TemporalId values, the frame rate upsampling filter is applicable for the sub-bitstream. When a sub-bitstream is extracted with the highest TemporalId value in the sub-bitstream being outside of the range of TemporalId values, the frame rate upsampling filter may not be applicable for the sub-bitstream.

In an example embodiment, the NNPFC SEI message syntax is appended with nnpfc_min_sublayer and nnpfc_max_sublayer syntax elements as follows:

| | Descriptor |
|---|---|
| nn_post_filter_characteristics( payloadSize ) { | |
| ... | |
| else if( nnpfc_purpose = = 5 ) { | |
| nnpfc_min_sublayer | u(3) |
| if( nnpfc_min_sublayer < 7 ) | |
| nnpfc_max_sublayer | u(3) |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| ... | |

The semantics of nnpfc_min_sublayer and nnpfc_max_sublayer may be specified as follows:
nnpfc_min_sublayer equal to 7 indicates that this NNPFC SEI message applies to this bitstream as well as any sub-bitstream extracted based on temporal sublayer identifier and specifies that the variables NnpfcMinSubLayer and NnpfcMaxSubLayer are set equal to 0 and 6, respectively. nnpfc_min_sublayer less than 7 specifies that the variable NnpfcMinSubLayer is set equal to nnpfc_min_sublayer.
nnpfc_max_sublayer, when present, indicates that this NNPFC SEI message applies to each sub-bitstream extracted based on the highest temporal sublayer identifier being any value in the range of nnpfc_min_sublayer to nnpfc_max_sublayer, inclusive. The variable NnpfcMaxSublayer is set equal to nnpfc_max_sublayer. The value of nnpfc_max_sublayer may be less than 7 and may be greater than or equal to nnpfc_min_sublayer.

The use of the NNPFC SEI message in VVC may be constrained as follows:
When a post-processing filter has nnpfc_purpose equal to 5 and Htid is less than NnpfcMinSublayer or greater than NnpfcMaxSublayer, the post-processing filter should not be applied even when it is activated by one or more NNPFA SEI messages.

The variable Htid identifies the highest temporal sublayer to be decoded.

In an embodiment, an NNPFA SEI message activating post-filter is appended to be indicative of a range of TemporalId values. In an embodiment, only such an NNPFA SEI message that activates a frame rate upsampling post-filter is appended to be indicative of a range of TemporalId values. When a sub-bitstream is extracted with the highest TemporalId value in the sub-bitstream being any value within the range of TemporalId values, the frame rate upsampling filter is applicable for the sub-bitstream. When a sub-bitstream is extracted with the highest TemporalId value in the sub-bitstream being outside of the range of TemporalId values, the frame rate upsampling filter may not be applicable for the sub-bitstream.

In an example embodiment, an NNPFA SEI message activating a post-filter is appended to be indicative of a range of TemporalId values as follows:

| | Descriptor |
|---|---|
| nn_post_filter_activation( payloadSize ) { | |
| nnpfa_min_sublayer | u(3) |
| if( nnpfa_min_sublayer < 7 ) | |
| nnpfa_max_sublayer | u(3) |
| nnpfa_target_id | ue(v) |
| nnpfa_cancel_flag | u(1) |
| if( !nnpfa_cancel_flag ) | |
| nnpfa_persistence_flag | u(1) |
| } | |

The semantics of nnpfa_min_sublayer and nnpfa_max_sublayer may be specified as follows:
nnpfa_min_sublayer equal to 7 indicates that this NNPFA SEI message applies to this bitstream as well as any sub-bitstream extracted based on temporal sublayer identifier and specifies that the variables NnpfaMinSubLayer and NnpfaMaxSubLayer are set equal to 0 and 6, respectively. nnpfa_min_sublayer less than 7 specifies that the variable NnpfaMinSubLayer is set equal to nnpfa_min_sublayer. When nnpfc_purpose in an NNPFC SEI message identified by the value of nnpfa_target_id is not equal to 5, nnpfa_min_sublayer shall be equal to 7.
nnpfa_max_sublayer, when present, indicates that this NNPFA SEI message applies to each sub-bitstream extracted based on the highest temporal sublayer identifier being any value in the range of nnpfa_min_sublayer to nnpfa_max_sublayer, inclusive. When nnpfa_max_sublayer is present, the variable NnpfaMaxSublayer is set equal to nnpfa_max_sublayer, the value of nnpfa_max_sublayer shall be less than 7, and the value of nnpfa_max_sublayer shall be greater than or equal to nnpfa_min_sublayer. nnpfa_max_sublayer, when present, shall be greater than or equal to temporal sublayer identifier of the PU including this SEI message.

The use of the post-filter(s) defined by NNPFC SEI message(s) in VVC may be constrained as follows: When a post-processing filter is activated by an NNPFA SEI message and Htid is less than NnpfaMinSublayer or greater than NnpfaMax Sublayer, the post-processing filter should not be applied.

In an embodiment, an NNPFA SEI message activating a frame rate upsampling post-filter is appended to be indicative of the input pictures for the post-filter. For example, the NNPFA SEI message may comprise a differential POC value for each input picture beyond the picture unit that includes the NNPFA SEI message. The input pictures may be indicated in decreasing POC value order. The first differential POC value may be the difference between the POC value the first indicated picture and the POC value of the picture unit including NNPFA SEI message, the second differential POC value, if any, may be the difference between the POC value of the second indicated picture and the POC value of the third indicated picture, the third differential POC value, if any, may be the difference between the POC value of the third indicated picture and the POC value of the fourth indicated picture, and so on.

In an embodiment, a temporal scalable nesting SEI message is indicative of the TemporalId values to which the SEI messages included in the temporal scalable nesting SEI message apply. An encoder includes an NNPFC SEI message defining a frame rate upsampling filter or an NNPFA SEI message activating a frame rate upsampling filter in a temporal scalable nesting SEI message and indicates a range of TemporalId values to which the temporal scalable nesting SEI message applies. When Htid is within the range of TemporalId values in the temporal scalable nesting SEI message, the frame rate upsampling filter included in the temporal scalable nesting SEI message is applicable. When a sub-bitstream is extracted with the highest TemporalId value in the sub-bitstream being any value within the range of TemporalId values in the temporal scalable nesting SEI message, the frame rate upsampling filter is applicable for the sub-bitstream. When a sub-bitstream is extracted with the highest TemporalId value in the sub-bitstream being outside of the range of TemporalId values in the temporal scalable nesting SEI message, the frame rate upsampling filter may not be applicable for the sub-bitstream.

In an embodiment, SEI NAL units are allowed to have TemporalId values different form the TemporalId value of the VCL NAL units of the picture unit including the SEI NAL units. Multiple NNPFA SEI messages that activate a frame rate upsampling post-filter may apply to the same picture unit. Each NNPFA SEI message may reside in an SEI NAL unit with different TemporalId value. A decoder uses the NNPFA SEI message included in the SEI NAL unit with the highest TemporalId value among the SEI NAL units including NNPFA SEI messages in the same picture unit for activating a post-filter, and omit the other NNPFA SEI messages.

In an embodiment, an encoder creates an SEI NAL unit with TemporalId equal to tId and includes therein an NNPFA SEI message that activates a frame rate upsampling post-filter trained for a frame rate of input pictures that is represented by pictures having TemporalId equal to or less than tId.

In an embodiment, an encoder creates an SEI NAL unit with TemporalId equal to tId and includes therein an NNPFA SEI message that activates a frame rate upsampling post-filter satisfactory for a frame rate of input pictures that is represented by pictures having TemporalId equal to or less than tId.

In an embodiment, the sample group description entry of the NNPFC sample group (e.g., NnpfcSeiEntry) is appended with information indicative of a range of TemporalId values. When a sub-bitstream is extracted with the highest TemporalId value in the sub-bitstream being any value within the range of TemporalId values, the frame rate upsampling filter is applicable for the sub-bitstream. When a sub-bitstream is extracted with the highest TemporalId value in the sub-bitstream being outside of the range of TemporalId values, the frame rate upsampling filter may not be applicable for the sub-bitstream.

In an embodiment, a reader supports the NNPFC sample group by performing the following implicit insertion of prefix SEI NAL units as a part of the bitstream reconstruction:
When a sample is mapped to at least one NnpfcSeiEntry with filter_update_flag equal to 0 and the sample is either a sync sample or the first sample of a sequence of samples associated with the same sample entry, the sample implicitly includes a prefix SEI NAL unit for each layer included in the track and each filter_id value mapped to the sample, and the prefix SEI NAL unit includes the NNPFC SEI message from the NnpfcSeiEntry with filter_update_flag equal to 0, followed by the NNPFC SEI message from the NnpfcSeiEntry with filter_update_flag equal to 1 that is mapped to the sample, if any.
When a sample is the first sample in a sequence of samples mapped to the same NnpfcSeiEntry with filter_update_flag equal to 1 and the sample is neither a sync sample nor the first sample of a sequence of samples associated with the same sample entry, the sample implicitly includes a prefix SEI NAL unit for each layer included in the track and each filter_id value mapped to the sample, and the prefix SEI NAL unit includes the NNPFC SEI message from the NnpfcSeiEntry with filter_update_flag equal to 1.

In an embodiment, a reader selects an operating point or is configured to reconstruct a bitstream for a given operating point, wherein the operating is characterized by a highest TemporalId value to be decoded. A reader performs implicit insertion of SEI NAL units based NNPFC sample group(s) only when the highest TemporalId value to be decoded is within the range of TemporalId values indicated in the NnpfcSeiEntry mapped to the samples used as a basis for bitstream reconstruction.

In an embodiment, the sample group description entry of the NNPFA sample group (e.g., NnpfaSeiEntry) is appended with information indicative of a range of TemporalId values. When a sub-bitstream is extracted with the highest TemporalId value in the sub-bitstream being any value within the range of TemporalId values, the post-filter is applicable for the sub-bitstream. When a sub-bitstream is extracted with the highest TemporalId value in the sub-bitstream being outside of the range of TemporalId values, the post-filter may not be applicable for the sub-bitstream.

In an embodiment, a reader selects an operating point or is configured to reconstruct a bitstream for a given operating point, wherein the operating is characterized by a highest TemporalId value to be decoded. A reader performs implicit insertion of SEI NAL units based NNPFA sample group(s) only when the highest TemporalId value to be decoded is within the range of TemporalId values indicated in the NnpfaSeiEntry mapped to the samples used as a basis for bitstream reconstruction.

In an embodiment, the grouping_type_parameter value of the NNPFA sample group is indicative of a range of TemporalId values. When a sub-bitstream is extracted with the highest TemporalId value in the sub-bitstream being any value within the range of TemporalId values, the post-filter is applicable for the sub-bitstream. When a sub-bitstream is extracted with the highest TemporalId value in the sub-bitstream being outside of the range of TemporalId values, the post-filter may not be applicable for the sub-bitstream.

In an embodiment, a reader selects an operating point or is configured to reconstruct a bitstream for a given operating point, wherein the operating is characterized by a highest TemporalId value to be decoded. A reader performs implicit insertion of SEI NAL units based NNPFA sample group(s) only when the highest TemporalId value to be decoded is within the range of TemporalId values indicated in the grouping_type_parameter of the NNPFA sample group(s).

An exposure time may refer to the duration of time that the camera's shutter is open when capturing a frame. The terms exposure time and shutter interval may be used interchangeably. The shutter interval affects the amount of motion blur that is captured in the image. A larger shutter interval may result in more motion blur, while a smaller shutter interval may result in less motion blur. Some source video sequences may be computer-generated and camera-captured video sequences may be processed to have a different frame rate than what was originally captured. Effective exposure time may be regarded as the exposure time that pictures of the video sequence essentially or effectively have, regardless of how the pictures were generated or processed.

When the exposure time of video frames has been short compared to the frame duration used in displaying, viewers might perceive strobing, which may be understood as a sequence of pictures observed like illuminated by a strobe light source. Temporally scalable video may suffer from strobing (temporal aliasing) when a temporally subsampled version of the video is displayed. Strobing may be perceived as stuttering and/or stop-motion animation and/or motion discontinuities. For example, when a 120-Hz video is coded in a temporally scalable manner, the exposure times are optimized for 120-Hz displaying, but actually 30-Hz or 60-Hz decoding may take place. A normal exposure time for a picture may be approximately half of the picture interval. For example, if the picture rate is 50 Hz, the interval between pictures is 1000/50 msec=20 msec, and a normal exposure time could be 10 msec.

It is possible to create video bitstreams including coded pictures of different effective exposure times. Such a bitstream may comprise multiple temporal sublayers, and pictures at different sublayers may have different effective exposure times. The effective exposure time of pictures at sublayer 0 may be suitable for displaying a decoded sub-bitstream that does not contain any higher sublayers. The effective exposure time of pictures at sublayer 1 may be suitable for displaying at a picture rate resulting from decoding a sub-bitstream that includes sublayers 0 and 1 but not any higher sublayers. A similar mapping of effective exposure times to sublayer 2 and higher may be made, provided that a bitstream has more than two sublayers.

The shutter interval information SEI message, e.g., as defined in VSEI, indicates the shutter interval for the associated video source pictures prior to encoding, e.g., for camera-captured content, the shutter interval is amount of time that an image sensor is exposed to produce each source picture. The shutter interval information SEI message may indicate, for each sublayer, the shutter interval that all pictures of the sublayer have within a coded layer video sequence.

When considering the example of having multiple temporal sublayers and pictures at different sublayers having different effective exposure times, a combination of decoded sublayers 0 and 1 might not be suitable for displaying as such, because of varying level of motion blur in different frames. Thus, a post-processing filter may be applied to deblur the decoded lowest sublayer. As a result of applying the deblur post-processing filter to the decoded frames of the lowest sublayer, the amount of motion blur in the deblurred decoded sublayer 0 and in the decoded sublayer 1 may look similar. A deblur post-filter may take multiple frames as input, such as the current frame to be deblurred and the previous frame that has a shorter effective exposure time than the current frame.

In an embodiment, a filter purpose of deblurring is defined for the NNPFC SEI message, e.g., as nnpfc_purpose equal to 6. When the deblurring filter purpose is indicated in the NNPFC SEI message, the number of input pictures for the deblurring filter may be inferred or may be indicated in the NNPFC SEI message.

In an embodiment, an auxiliary input of shutter interval is defined for the NNPFC SEI message, and may be provided for each input picture for filtering. In an embodiment, a decoder may obtain the shutter intervals from the shutter interval information SEI message and use the obtained shutter intervals as an auxiliary input for a post-filter, which may be a deblurring post-filter.

Several embodiments have been described in relation to a frame rate upsampling filter or a frame rate upsampling post-filter. It is to be understood that embodiments similarly apply to a filter or a post-filter of any purpose. For example, embodiments apply to a deblurring post-filter similarly to how embodiments apply to a frame rate upsampling post-filter.

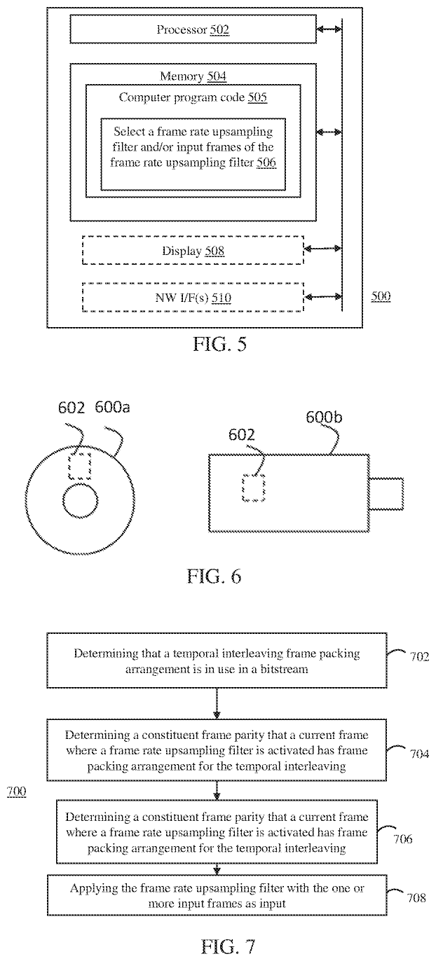

FIG. 5 is an example apparatus 500, which may be implemented in hardware, and caused to implement the examples described herein. The apparatus 500 comprises at least one processor 502, at least one non-transitory memory 504 including computer program code 505, wherein the at least one non-transitory memory 504 and the computer program code 505 are configured to, with the at least one processor 502, cause the apparatus 500 to select a frame rate upsampling filter and/or an input frames of the frame rate upsampling filter 506, based on the examples described herein. Examples of the frame rate upsampling filter includes, but is not limited to, a frame rate upsampling post-filter or a frame rate upsampling post-processing filter.

The apparatus 500 optionally includes a display 508 that may be used to display content during rendering. The apparatus 500 optionally includes one or more network (NW) interfaces (I/F(s)) 510. The NW I/F(s) 510 may be wired and/or wireless and communicate over the Internet/other network(s) via any communication technique. The NW I/F(s) 510 may comprise one or more transmitters and one or more receivers. The N/W I/F(s) 510 may comprise standard well-known components such as an amplifier, filter, frequency-converter, (de) modulator, and encoder/decoder circuitry(ies) and one or more antennas.

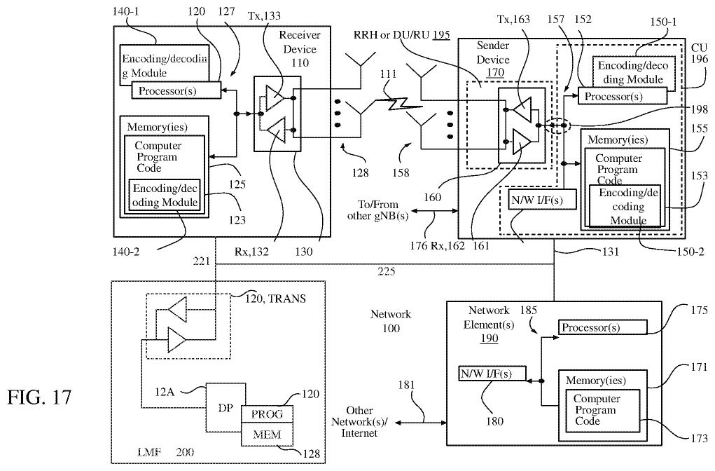

The apparatus 500 may be a remote, virtual or cloud apparatus. The apparatus 500 may be either a coder or a decoder, or both a coder and a decoder. The at least one non-transitory memory 504 may be implemented using any suitable data storage technology, such as semiconductor based memory devices, flash memory, magnetic memory devices and systems, optical memory devices and systems, fixed memory and removable memory. The at least one non-transitory memory 504 may comprise a database for storing data. The apparatus 500 need not comprise each of the features mentioned, or may comprise other features as well. The apparatus 500 may correspond to or be another embodiment for example, apparatuses shown in FIG. 17, including a receiver device 110, a sender device 170, or a network element(s) 190.

FIG. 6 shows a schematic representation of non-volatile memory media 600a (e.g., computer/compact disc (CD) or digital versatile disc (DVD)) and 600b (e.g., universal serial bus (USB) memory stick) storing instructions and/or parameters 602 which when executed by a processor allows the processor to perform one or more of the steps of the methods described herein.

FIG. 7 is an example method 700 to implement the examples described herein, in accordance with an embodiment. At 702, the method 700 includes determining that a temporal interleaving frame packing arrangement is in use in a bitstream. At 704, the method 700 includes determining a constituent frame parity that a current frame where a frame rate upsampling filter is activated has frame packing arrangement for the temporal interleaving. At 706, the method 700 includes selecting one or more input frames for the frame rate upsampling filter comprising the determined constituent frame parity. At 708, the method 700 includes applying the frame rate upsampling filter with the one or more input frames as input. Examples of the frame rate upsampling filter includes, but is not limited to, a frame rate upsampling post-filter or a frame rate upsampling post-processing filter.

The method 700 may be performed with an apparatus described herein, for example, the apparatus 500.

FIG. 8 is an example method 800 to implement the examples described herein, in accordance with another embodiment. At 802, the method 800 includes determining that a temporal interleaving frame packing arrangement is in use in a bitstream. At 804, the method 800 includes selecting one or more input frames for a frame rate upsampling filter. At 806, the method 800 includes applying the frame rate upsampling filter with the one or more input frames and information indicative of the temporal interleaving frame packing arrangement as inputs. Examples of the frame rate upsampling filter includes, but is not limited to, a frame rate upsampling post-filter or a frame rate upsampling post-processing filter.

The method 800 may be performed with an apparatus described herein, for example, the apparatus 500.

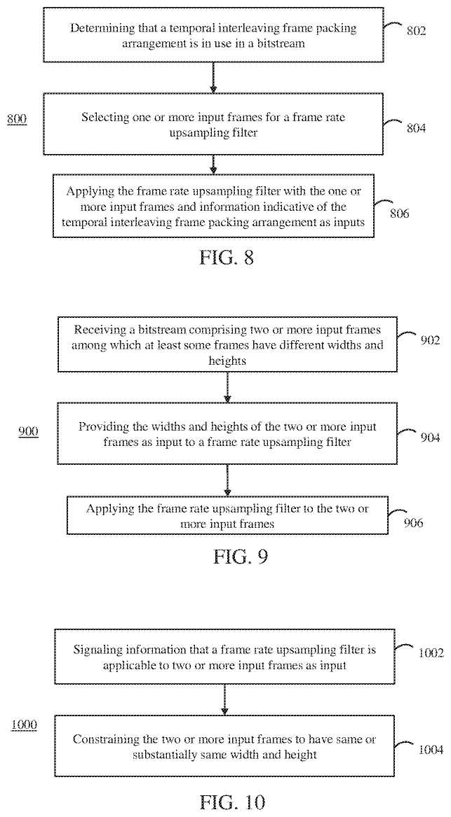

FIG. 9 is an example method 900 to implement the examples described herein, in accordance with yet another embodiment. At 902, the method 900 includes receiving a bitstream comprising two or more input frames among which at least some frames have different widths and heights. At 904, the method 900 includes providing the widths and heights of the two or more input frames as input to a frame rate upsampling filter. At 906, the method 900 includes applying the frame rate upsampling filter to the two or more input frames. Examples of the frame rate upsampling filter includes, but is not limited to, a frame rate upsampling post-filter or a frame rate upsampling post-processing filter.

The method 900 may be performed with an apparatus described herein, for example, the apparatus 500.

FIG. 10 is an example method 1000 to implement the examples described herein, in accordance with still another embodiment. At 1002, the method 1000 includes signaling information that a frame rate upsampling filter is applicable to two or more input frames as input. At 1004, the method 1000 includes constraining the two or more input frames to have same or substantially same width and height. Examples of the frame rate upsampling filter includes, but is not limited to, a frame rate upsampling post-filter or a frame rate upsampling post-processing filter.

The method 1000 may be performed with an apparatus described herein, for example, the apparatus 500.

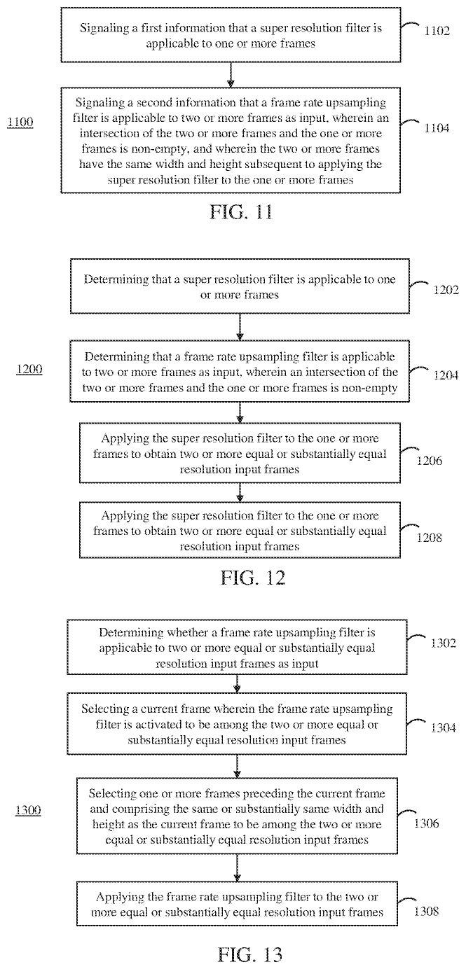

FIG. 11 is an example method 1100 to implement the examples described herein, in accordance with still another embodiment. At 1102, the method 1100 includes signaling a first information that a super resolution filter is applicable to one or more frames. At 1104, the method 1100 includes signaling a second information that a frame rate upsampling filter is applicable to two or more frames as input, wherein an intersection of the two or more frames and the one or more frames is non-empty, and wherein the two or more frames have the same width and height subsequent to applying the super resolution filter to the one or more frames. Examples of the frame rate upsampling filter includes, but is not limited to, a frame rate upsampling post-filter or a frame rate upsampling post-processing filter.

The method 1100 may be performed with an apparatus described herein, for example, the apparatus 500.

FIG. 12 is an example method 1200 to implement the examples described herein, in accordance with still another embodiment. At 1202, the method 1200 includes determining that a super resolution filter is applicable to one or more frames. At 1204, the method 1200 includes determining that a frame rate upsampling filter is applicable to two or more frames as input, wherein an intersection of the two or more frames and the one or more frames is non-empty. At 1206, the method 1200 includes applying the super resolution filter to the one or more frames to obtain two or more equal or substantially equal resolution input frames. At 1208, the method 1200 includes applying the frame rate upsampling filter to the two or more equal or substantially equal resolution input frames. Examples of the frame rate upsampling filter includes, but is not limited to, a frame rate upsampling post-filter or a frame rate upsampling post-processing filter.

The method 1200 may be performed with an apparatus described herein, for example, the apparatus 500.

FIG. 13 is an example method 1300 to implement the examples described herein, in accordance with still another embodiment. At 1302, the method 1300 includes determining whether a frame rate upsampling filter is applicable to two or more equal or substantially equal resolution input frames as input. At 1304, the method 1300 includes selecting a current frame wherein the frame rate upsampling filter is activated to be among the two or more equal or substantially equal resolution input frames. At 1306, the method 1300 includes selecting one or more frames preceding the current frame and comprising the same or substantially same width and height as the current frame to be among the two or more equal or substantially equal resolution input frames. At 1308, the method 1300 includes applying the frame rate upsampling filter to the two or more equal or substantially equal resolution input frames. Examples of the frame rate upsampling filter includes, but is not limited to, a frame rate upsampling post-filter or a frame rate upsampling post-processing filter.

The method 1300 may be performed with an apparatus described herein, for example, the apparatus 500.

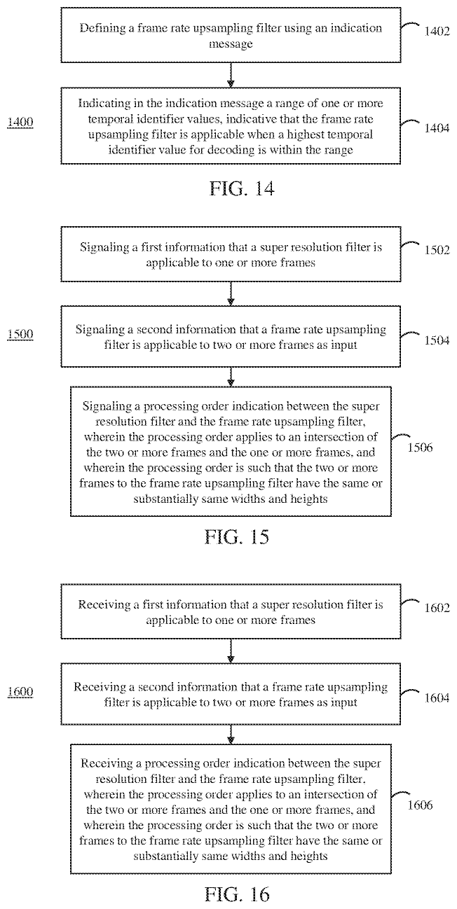

FIG. 14 is an example method 1400 to implement the examples described herein, in accordance with still another embodiment. At 1402, the method 1400 includes defining a frame rate upsampling filter using an indication message. At 1404, the method 1400 includes indicating in the indication message a range of one or more temporal identifier values, indicative that the frame rate upsampling filter is applicable when a highest temporal identifier value for decoding is within the range. Examples of the frame rate upsampling filter includes, but is not limited to, a frame rate upsampling post-filter or a frame rate upsampling post-processing filter.

The method 1400 may be performed with an apparatus described herein, for example, the apparatus 500.

FIG. 15 is an example method 1500 to implement the examples described herein, in accordance with still another embodiment. At 1502, the method 1500 includes signaling a first information that a super resolution filter is applicable to one or more frames. At 1504, the method 1500 includes signaling a second information that a frame rate upsampling filter is applicable to two or more frames as input. At 1506, the method 1500 includes signaling a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially widths and heights. Examples of the frame rate upsampling filter includes, but is not limited to, a frame rate upsampling post-filter or a frame rate upsampling post-processing filter.

The method 1500 may be performed with an apparatus described herein, for example, the apparatus 500.

FIG. 16 is an example method 1600 to implement the examples described herein, in accordance with still another embodiment. At 1602, the method 1600 includes receiving a first information that a super resolution filter is applicable to one or more frames. At 1604, the method 1600 includes receiving a second information that a frame rate upsampling filter is applicable to two or more frames as input. At 1606, the method 1600 includes receiving a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially same widths and heights. Examples of the frame rate upsampling filter includes, but is not limited to, a frame rate upsampling post-filter or a frame rate upsampling post-processing filter.

The method 1600 may be performed with an apparatus described herein, for example, the apparatus 500.

FIG. 17 shows a block diagram of one possible and non-limiting exemplary system in which the exemplary embodiments may be practiced. As shown in FIG. 17, a receiver device 110 is in wireless communication with a wireless network 100. A UE is a wireless, typically mobile device that can access a wireless network. The receiver device 110 includes one or more processors 120, one or more computer readable memories 125, and one or more transceivers 130 interconnected through one or more buses 127. Each of the one or more transceivers 130 includes a receiver Rx, 132 and a transmitter Tx 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more computer readable memories 125 include computer program code 123. The receiver device 110 may include an encoding and/or decoding module 140 which is configured to perform the example embodiments of the invention as described herein. The encoding and/or decoding module 140-1 or 140-2 may be implemented in hardware by itself of as part of the processors and/or the computer program code of the receiver device 110. encoding and/or decoding module 140 comprising one of or both parts 140-1 and/or 140-2, which may be implemented in a number of ways. encoding and/or decoding module 140 may be implemented in hardware as encoding and/or decoding module 140-1, such as being implemented as part of the one or more processors 120. The encoding and/or decoding module 140-1 may be implemented also as an integrated circuit or through other hardware such as a programmable gate array. In another example, the encoding and/or decoding module 140 may be implemented as encoding and/or decoding module 140-2, which is implemented as computer program code 123 and is executed by the one or more processors 120. Further, it is noted that the encoding and/or decoding modules 140-1 and/or 140-2 are optional. For instance, the one or more computer readable memories 125 and the computer program code 123 may be configured, with the one or more processors 120, to cause the receiver device 110 to perform one or more of the operations as described herein. The receiver device 110 communicates with sender device 170 via a wireless link 111 and the LMF 200 via link 221.

The sender device 170 (NR/5G Network device e.g., for LTE, long term evolution) that provides access by wireless devices such as the receiver device 110 to the wireless network 100. The sender device 170 includes one or more processors 152, one or more computer readable memories 155, one or more network interfaces (N/W I/F(s)) 161, and one or more transceivers 160 interconnected through one or more buses 157. Each of the one or more transceivers 160 includes a receiver Rx 162 and a transmitter Tx 163. The one or more transceivers 160 are connected to one or more antennas 158. The one or more computer readable memories 155 include computer program code 153. The sender device 170 includes encoding and/or decoding module 150 which is configured to perform example embodiments of the invention as described herein. The encoding and/or decoding module 150 may comprise one of or both parts 150-1 and/or 150-2, which may be implemented in a number of ways. The encoding and/or decoding module 150 may be implemented in hardware by itself or as part of the processors and/or the computer program code of the sender device 170. The encoding and/or decoding module 150-1, such as being implemented as part of the one or more processors 152. The encoding and/or decoding module 150-1 may be implemented also as an integrated circuit or through other hardware such as a programmable gate array. In another example, the encoding and/or decoding module 150 may be implemented as the encoding and/or decoding module 150-2, which is implemented as computer program code 153 and is executed by the one or more processors 152. Further, it is noted that the encoding and/or decoding modules 150-1 and/or 150-2 are optional. For instance, the one or more computer readable memories 155 and the computer program code 153 may be configured to cause, with the one or more processors 152, the sender device 170 to perform one or more of the operations as described herein. The one or more network interfaces 161 communicate over a network such as via the links 176, 221, and 131. Two or more sender device 170 may communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the sender device 170 being physically in a different location from the RRH, and the one or more buses 157 could be implemented in part as fiber optic cable to connect the other elements of the sender device 170 to the RRH 195.

It is noted that description herein indicates that “cells” perform functions, but it should be clear that the gNB that forms the cell will perform the functions. The cell makes up part of a gNB. That is, there can be multiple cells per gNB.

The wireless network 100 may include a NCE/MME/SGW/UDM/PCF/AMM/SMF 190, which can comprise a network control element (NCE), and/or serving gateway (SGW) 190, and/or MME (Mobility Management Entity) and/or SGW (Serving Gateway) functionality, and/or user data management functionality (UDM), and/or PCF (Policy Control) functionality, and/or Access and Mobility Management (AMM) functionality, and/or Session Management (SMF) functionality, and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF 190 is configurable to perform operations in accordance with example embodiments of the invention in any of an LTE, NR, 5G and/or any standards based communication technologies being performed or discussed at the time of this application.

The sender device 170 is coupled via a link 131 to the NCE/MME/SGW 190 and via link 131 and link 225 to the LMF 200. The link 131 or link 225 may be implemented as, e.g., an S1 interface. The NCE/MME/SGW 190 includes one or more processors 175, one or more computer readable memories 171, and one or more network interfaces (N/W I/F(s)) 180, interconnected through one or more buses 185. The one or more computer readable memories 171 include computer program code 173. The one or more computer readable memories 171 and the computer program code 173 are configured to, with the one or more processors 175, cause the NCE/MME/SGW 190 to perform one or more operations. In addition, the NCE/MME/SGW 190, as are the other devices, is equipped to perform operations of such as by controlling the receiver device 110 and/or sender device 170 for 5G and/or NR operations in addition to any other standards operations at the time of this application.

The LMF 200 (NR/5G Node B, an evolved NB, or LTE device) is a network node such as a node including a location management function device (e.g., for NR or LTE long term evolution) that communicates with devices such the sender device 170 and receiver device 110 of FIG. 17. The LMF 12 provides access to wireless devices such as the UE 10 to the wireless network 1. The LMF 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 221 with the receiver device 110. The one or more memories MEM 12B and the computer program code PROG 12C are configured to cause, with the one or more processors DP 12A, the LMF 12 to perform one or more of the operations as described herein. The LMF 12 may communicate with the gNB or eNB 170 such as via link 225 and 131. Further, the link 221, 225, or 131 and/or any other link may be wired or wireless or both and may implement, e.g., an X2 or Xn interface. Further the link 221, 225, or 131 and may be through other network devices such as, but not limited to an NCE/MME/SGW/UDM/PCF/AMF/SMF/LMF 14 device as in FIG. 13. The LMF 12 may perform functionalities of an MME (Mobility Management Entity) or SGW (Serving Gateway), such as a User Plane Functionality, and/or an Access Management functionality for LTE and similar functionality for 5G.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and computer readable memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions and other functions as described herein to control a network device such as the receiver device 110, sender device 170, and/or NCE/MME/SGW 190 as in FIG. 17.

It is noted that functionality(ies), in accordance with example embodiments of the invention, of any devices as shown in FIG. 17, e.g., the receiver device 110 and/or sender device 170 can also be implemented by other network nodes, e.g., a wireless or wired relay node (a.k.a., integrated access and/or backhaul (IAB) node). In the IAB case, UE functionalities may be carried out by MT (mobile termination) part of the IAB node, and gNB functionalities by DU (Data Unit) part of the IAB node, respectively. These devices can be linked to the receiver device 110 as in FIG. 17 at least via the wireless link 111 and/or via the NCE/MME/SGW 190 using link 199 to Other Network(s)/Internet as in FIG. 17.

As similarly stated above, example embodiments of the invention relate to selection of frame rate upsampling post-filter and/or its input frame.

A non-transitory computer-readable medium (Memory(ies) 155 as in FIG. 17) storing program code (Computer Program Code 153 and/or the encoding and/or decoding module 150-2 as in FIG. 17), the program code executed by at least one processor (Processor(s) 152 and/or the encoding and/or decoding module 150-1 as in FIG. 17) to perform the operations as at least described in the paragraphs above.

In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) that a temporal interleaving frame packing arrangement is in use in a bitstream; means for determining (Memory(ies) 125, 155; Computer Program Code 123, 153; encoding/decoding module 140-1, 150-1; and Processor(s) 120, 152 as in FIG. 17) a constituent frame parity that a current frame where a frame rate upsampling filter is activated has frame packing arrangement for the temporal interleaving; means for selecting (Memory(ies) 125, 155; Computer Program Code 123, 153; encoding/decoding module 140-1, 150-1; and Processor(s) 120, 152 as in FIG. 17) one or more input frames for the frame rate upsampling filter comprising the determined constituent frame parity; and means for applying (Memory(ies) 125, 155; Computer Program Code 123, 153; encoding/decoding module 140-1, 150-1; and Processor(s) 120, 152 as in FIG. 17) the frame rate upsampling filter with the one or more input frames as input

In an example embodiment to the paragraph above, wherein at least the means for determining, selecting, and applying comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) that a temporal interleaving frame packing arrangement is in use in a bitstream; means for selecting (Memory(ies) 125, 155; Computer Program Code 123, 153; encoding/decoding module 140-1, 150-1; and Processor(s) 120, 152 as in FIG. 17) one or more input frames for a frame rate upsampling filter; and means for applying (Memory(ies) 125, 155; Computer Program Code 123, 153; encoding/decoding module 140-1, 150-1; and Processor(s) 120, 152 as in FIG. 17) the frame rate upsampling filter with the one or more input frames and information indicative of the temporal interleaving frame packing arrangement as inputs.

In an example embodiment to the paragraph above, wherein at least the means for determining, selecting, and applying comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for receiving (One or more antennas/Remote radio head 128, 195; Memory(ies) 125, 155; Computer Program Code 123, 153; encoding/decoding module 140-1, 150-1; and Processor(s) 120, 152 as in FIG. 17) a bitstream comprising two or more input frames among which at least some frames have different widths and heights; means for providing (Bus(es) 127, 157; Memory(ies) 125, 155; Computer Program Code 123, 153; encoding/decoding module 140-1, 150-1; and Processor(s) 120, 152 as in FIG. 17) the widths and heights of the two or more input frames as input to a frame rate upsampling filter; and means for applying (Memory(ies) 125, 155; Computer Program Code 123, 153; encoding/decoding module 140-1, 150-1; and Processor(s) 120, 152 as in FIG. 17) the frame rate upsampling filter to the two or more input frames.

In an example embodiment to the paragraph above, wherein at least the means for receiving, providing, and applying comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) information that a frame rate upsampling filter is applicable to two or more input frames as input; and means for constraining (Memory(ies) 125, 155; Computer Program Code 123, 153; encoding/decoding module 140-1, 150-1; and Processor(s) 120, 152 as in FIG. 17) the two or more input frames to have same or substantially same width and height.

In an example embodiment to the paragraph above, wherein at least the means for signaling and constraining comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) a first information that a super resolution filter is applicable to one or more frames; and means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) a second information that a frame rate upsampling filter is applicable to two or more frames as input, wherein an intersection of the two or more frames and the one or more frames is non-empty, and wherein the two or more frames have the same width and height subsequent to applying the super resolution filter to the one or more frames.

In an example embodiment to the paragraph above, wherein at least the means for signaling and constraining comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) that a super resolution filter is applicable to one or more frames; means for determining (Memory(ies) 125, 155; Computer Program Code 123, 153; encoding/decoding module 140-1, 150-1; and Processor(s) 120, 152 as in FIG. 17) that a frame rate upsampling filter is applicable to two or more frames as input, wherein an intersection of the two or more frames and the one or more frames is non-empty; means for applying (Memory(ies) 125, 155; Computer Program Code 123, 153; encoding/decoding module 140-1, 150-1; and Processor(s) 120, 152 as in FIG. 17) the super resolution filter to the one or more frames to obtain two or more equal or substantially equal resolution input frames; and means for applying (Memory(ies) 125, 155; Computer Program Code 123, 153; encoding/decoding module 140-1, 150-1; and Processor(s) 120, 152 as in FIG. 17) the frame rate upsampling filter to the two or more equal or substantially equal resolution input frames.

In an example embodiment to the paragraph above, wherein at least the means for determining and applying comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) whether a frame rate upsampling filter is applicable to two or more equal or substantially equal resolution input frames as input; means for selecting In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) a current frame wherein the frame rate upsampling filter is activated to be among the two or more equal or substantially equal resolution input frames; means for selecting In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) one or more frames preceding the current frame and comprising the same or substantially same width and height as the current frame to be among the two or more equal or substantially equal resolution input frames; and means for applying In accordance with an example embodiments as described above there is an apparatus comprising: means for determining (Memory(ies) 125, 155; Computer Program Code 123, 153; encoding/decoding module 140-1, 150-1; and Processor(s) 120, 152 as in FIG. 17) the frame rate upsampling filter to the two or more equal or substantially equal resolution input frames.

In an example embodiment to the paragraph above, wherein at least the means for determining, selecting, and applying comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for defining (Memory(ies) 125, 155; Computer Program Code 123, 153; encoding/decoding module 140-1, 150-1; and Processor(s) 120, 152 as in FIG. 17) a frame rate upsampling filter using an indication message; and means for indicating (Memory(ies) 125, 155; Computer Program Code 123, 153; encoding/decoding module 140-1, 150-1; and Processor(s) 120, 152 as in FIG. 17) in the indication message a range of one or more temporal identifier values, indicative that the frame rate upsampling filter is applicable when a highest temporal identifier value for decoding is within the range.

In an example embodiment to the paragraph above, wherein at least the means for defining and selecting comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) a first information that a super resolution filter is applicable to one or more frames; means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) a second information that a frame rate upsampling filter is applicable to two or more frames as input; and means for signaling (One or more antennas/Remote radio head 128, 195; Memory(ies) 125, 155; Computer Program Code 123, 153; encoding/decoding module 140-1, 150-1; and Processor(s) 120, 152 as in FIG. 17) a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially widths and heights

In an example embodiment to the paragraph above, wherein at least the means for signaling comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

In accordance with an example embodiments as described above there is an apparatus comprising: means for receiving (One or more antennas/Remote radio head 128, 195; Memory(ies) 125, 155; Computer Program Code 123, 153; encoding/decoding module 140-1, 150-1; and Processor(s) 120, 152 as in FIG. 17) a first information that a super resolution filter is applicable to one or more frames; means for receiving (One or more antennas/Remote radio head 128, 195; Memory(ies) 125, 155; Computer Program Code 123, 153; encoding/decoding module 140-1, 150-1; and Processor(s) 120, 152 as in FIG. 17) a second information that a frame rate upsampling filter is applicable to two or more frames as input; and means for receiving (One or more antennas/Remote radio head 128, 195; Memory(ies) 125, 155; Computer Program Code 123, 153; encoding/decoding module 140-1, 150-1; and Processor(s) 120, 152 as in FIG. 17) a processing order indication between the super resolution filter and the frame rate upsampling filter, wherein the processing order applies to an intersection of the two or more frames and the one or more frames, and wherein the processing order is such that the two or more frames to the frame rate upsampling filter have the same or substantially widths and heights

In an example embodiment to the paragraph above, wherein at least the means for receiving comprises a non-transitory computer readable medium [Memory(ies) 125, 155 as in FIG. 17] encoded with a computer program [Computer Program Code 123, 153 and/or the encoding/decoding module 140-1, 150-2 as in FIG. 17] executable by at least one processor [Processor(s) 120, 152 as in FIG. 17].

A non-transitory computer-readable medium (Memory(ies) 125, 155 as in FIG. 17) storing program code (Computer Program Code 123, 153 and/or the encoding/decoding Module 140-1, 150-2 as in FIG. 17), the program code executed by at least one processor (Processor(s) 120, 152) to perform the operations as at least described in the paragraphs above.

Further, in accordance with example embodiments of the invention there is circuitry for performing operations in accordance with example embodiments of the invention as disclosed herein. This circuitry may include any type of circuitry including content coding circuitry, content decoding circuitry, processing circuitry, image generation circuitry, data analysis circuitry, and the like.). Further, this circuitry may include discrete circuitry, application-specific integrated circuitry (ASIC), and/or field-programmable gate array circuitry (FPGA), and the like. as well as a processor specifically configured by software to perform the respective function, or dual-core processors with software and corresponding digital signal processors, and the like.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments as disclosed in this application this application, the “circuitry” provided may include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

In the above, some embodiments have been described with reference to specific SEI messages, such as NNPFC SEI message(s) and/or NNPFA SEI message(s). It needs to be understood that embodiments may similarly be realized with any SEI messages of similar nature. For example, some embodiments may be realized with post-filter characteristics and/or activation SEI message(s) where post-filters are not based on neural networks.

In the above, some example embodiments have been described with reference to an SEI message or an SEI NAL unit. It needs to be understood, however, that embodiments may similarly be realized with any similar structures or data units, such as metadata OBUs. Where example embodiments have been described with SEI messages included in a structure, any independently parsable structures could likewise be used in embodiments. Specific SEI NAL unit and SEI message syntax structures have been presented in example embodiments, but it needs to be understood that embodiments generally apply to any syntax structures with a similar intent as SEI NAL units and/or SEI messages.

In the above, some embodiments have been described with reference to a post-filter or a post-processing filter. It is to be understood that embodiments may similarly be realized with reference to a loop filter.

In the above, some embodiments have been described with reference to a reader, which is to be understood to be any entity reading, parsing, interpreting, or otherwise processing a media file or one or more fragments of a media file. Terms reader, file reader, player, file player, parser, and file parser may be used interchangeably.

In the above, some embodiments have been described with the help of syntax of a file format, such as ISOBMFF. It needs to be understood, however, that the corresponding structure and/or computer program may reside at a file writer for generating a file and/or at a file reader for parsing or interpreting a file.

In the above, where example embodiments have been described with reference to a file writer, it needs to be understood that the resulting file and the file reader have corresponding elements in them. Likewise, where example embodiments have been described with reference to a file reader, it needs to be understood that the file writer has structure and/or computer program for generating the file to be parsed or interpreted by the file reader.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-41. (canceled)

42. A method comprising:
determining that a super resolution filter is applicable to one or more frames;
determining that a frame rate upsampling filter is applicable to two or more frames as an input, wherein an intersection of the two or more frames and the one or more frames is non-empty;
applying the super resolution filter to the one or more frames to obtain two or more equal or substantially equal resolution input frames; and
applying the frame rate upsampling filter to the two or more equal or substantially equal resolution input frames.

43. The method claim 42 further comprising:
applying the super resolution filter, when an input frame to the super resolution filter comprises an incompatible width or height to be an input to the frame rate upsampling filter of the two or more input frames.

44. The method of claim 42 further comprising:
receiving a first information for determining that the super resolution filter is applicable to the one or more frames; and
receiving a second information for determining that the frame rate upsampling filter is applicable to the two or more frames as input.

45. The method of claim 44 further comprising: receiving a processing order indication between the super resolution filter and the frame rate upsampling filter, wherein the processing order applies to the intersection of the two or more frames and the one or more frames, and wherein the processing order is such that the two or more frames to the frame rate upsampling filter have the same or substantially widths and heights.

46. The method of claim 45 further comprising:
receiving a first type value, a first identifier value, a second type value, and a second identifier value in the processing order indication, wherein the first type value, the first identifier value, the second type value, and the second identifier value indicates the respective processing order of the frame rate upsampling filter and the super resolution filter; and
decoding the first type value, the first identifier value, the second type value and the second identifier value from the processing order indication, to determine the respective processing order of the frame rate upsampling filter and the super resolution filter.

47. A method comprising:
signaling a first information intended to be used for determining that a super resolution filter is applicable to one or more frames;
signaling a second information intended to be used for determining that a frame rate upsampling filter is applicable to two or more frames as input, wherein an intersection of the two or more frames and the one or more frames is non-empty;
wherein the super resolution filter is intended to be applied to the one or more frames to obtain two or more equal or substantially equal resolution input frames; and
wherein the frame rate upsampling filter is intended to be applied to the two or more equal or substantially equal resolution input frames.

48. The method claim 47, wherein the super resolution filter is intended to be applied, when an input frame to the super resolution filter comprises an incompatible width or height to be an input to the frame rate upsampling filter of the two or more input frames.

49. The method of claim 47 wherein the
the first information is signaled in a first information message; and
the second information is signaled in a second information message.

50. The method of claim 47 further comprising: signaling a processing order indication between the super resolution filter and the frame rate upsampling filter, wherein the processing order applies to the intersection of the two or more frames and the one or more frames, and wherein the processing order is such that the two or more frames to the frame rate upsampling filter have the same or substantially widths and heights.

51. The method of claim 50 further comprising signaling a first type value, a first identifier value, a second type value, and a second identifier value in the processing order indication to indicate the respective processing order of the frame rate upsampling filter and the super resolution filter.

52. An apparatus comprising:
at least one processor; and
at least one memory storing instructions that, when executed by the at least one processor, cause the apparatus at least to perform:
determining that a super resolution filter is applicable to one or more frames;
determining that a frame rate upsampling filter is applicable to two or more frames as input, wherein an intersection of the two or more frames and the one or more frames is non-empty;
applying the super resolution filter to the one or more frames to obtain two or more equal or substantially equal resolution input frames; and
applying the frame rate upsampling filter to the two or more equal or substantially equal resolution input frames.

53. The apparatus of claim 52, wherein the apparatus is further caused to perform:
applying the super resolution filter, when an input frame to the super resolution filter comprises an incompatible width or height to be an input to the frame rate upsampling filter of the two or more input frames.

54. The apparatus of claim 52, wherein the apparatus is further caused to perform:
receiving a first information for determining that the super resolution filter is applicable to the one or more frames; and
receiving a second information for determining that the frame rate upsampling filter is applicable to the two or more frames as input.

55. The apparatus of claim 54, wherein the apparatus is further caused to perform: receiving a processing order indication between the super resolution filter and the frame rate upsampling filter, wherein the processing order applies to the intersection of the two or more frames and the one or more frames, and wherein the processing order is such that the two or more frames to the frame rate upsampling filter have the same or substantially widths and heights.

56. The apparatus of claim 55, wherein the apparatus is further caused to perform:
receiving a first type value, a first identifier value, a second type value, and a second identifier value in the processing order indication, wherein the first type value, the first identifier value, the second type value, and the second identifier value indicates the respective processing order of the frame rate upsampling filter and the super resolution filter; and
decoding the first type value, the first identifier value, the second type value and the second identifier value from the processing order indication, to determine the respective processing order of the frame rate upsampling filter and the super resolution filter.

57. An apparatus comprising:
at least one processor; and
at least one memory storing instructions that, when executed by the at least one processor, cause the apparatus at least to perform:
signaling a first information intended to be used for determining that a super resolution filter is applicable to one or more frames;
signaling a second information intended to be used for determining that a frame rate upsampling filter is applicable to two or more frames as input, wherein an intersection of the two or more frames and the one or more frames is non-empty;
wherein the super resolution filter is intended to be applied to the one or more frames to obtain two or more equal or substantially equal resolution input frames; and
wherein the frame rate upsampling filter is intended to be applied to the two or more equal or substantially equal resolution input frames.

58. The apparatus of claim 57, wherein the super resolution filter is intended to be applied, when an input frame to the super resolution filter comprises an incompatible width or height to be an input to the frame rate upsampling filter of the two or more input frames.

59. The apparatus of claim 57, wherein:
the first information is signaled in a first information message; and
the second information is signaled in a second information message.

60. The apparatus of claim 57, wherein the apparatus is further caused to perform: signaling a processing order indication between the super resolution filter and the frame rate upsampling filter, wherein the processing order applies to the intersection of the two or more frames and the one or more frames, and wherein the processing order is such that the two or more frames to the frame rate upsampling filter have the same or substantially widths and heights.

61. The apparatus of claim 60, wherein the apparatus is further caused to perform signaling a first type value, a first identifier value, a second type value, and a second identifier value in the processing order indication to indicate the respective processing order of the frame rate upsampling filter and the super resolution filter.
